(19) United States
(12) Patent Application Publication
(10) Pub. No.: US 2006/0014092 A1
(43) Pub. Date: Jan. 19, 2006

(54) Electrophotographic photoreceptor, electrophotographic cartridge and electrophotographic apparatus

(76) Inventors: Hidemi Nukada, Minamiashigara-shi (JP); Hirofumi Nakamura, Minamiashigara-shi (JP); Taketoshi Hoshizaki, Minamiashigara-shi (JP); Yu Qi, Oakville (CA); Nan-Xing Hu, Oakville (CA); Ah-Mee Hor, Mississauga (CA)

Correspondence Address: OLIFF & BERRIDGE, PLC, P.O. BOX 19928, ALEXANDRIA, VA, 22320, US

(21) Appl. No.: 11/083,032

(22) Filed: Mar. 18, 2005

(30) Foreign Application Priority Data
Jul. 16, 2004 (JP) 2004-210752

(51) Int. Cl. G03G 5/14

(52) U.S. Cl. 430/60; 399/159

(57) ABSTRACT

An electrophotographic photoreceptor including at least an undercoat layer and a photosensitive layer on a conductive substrate, in which the undercoat layer includes metal oxide fine particles to which an electron acceptor compound is attached.

### CROSS-REFERENCE TO RELATED APPLICATION

This application claims priority under 35 USC 119 from Japanese Patent Application No. 2004-210752, the disclosure of which is incorporated by reference herein.

### BACKGROUND OF THE INVENTION

1. Field of the Invention

The present invention relates to an electrophotographic photoreceptor, an electrophotographic cartridge and an electrophotographic apparatus adapted for use in electrophotographic image formation.

2. Description of the Related Art

An electrophotographic process, as it is capable of achieving a high speed and providing a high print quality, is utilized in electrophotographic apparatus such as a copying machine or a laser beam printer.

An electrophotographic photoreceptor, employed in such an electrophotographic apparatus, is principally an organic electrophotographic photoreceptor utilizing an organic photoconductive material, and is changing, in its structure, to an electrophotographic photoreceptor of function-separation type in which a charge transport material and a charge generation material are dispersed in separate layers, with an improvement in the performance.

The electrophotographic photoreceptor of such function-separation type is currently often formed by forming an undercoat layer on an aluminum substrate and then forming a photosensitive layer including a charge generation layer and a charge transport layer thereon.

In such electrophotographic photoreceptor, improvements in the stability in repeated use of the photoreceptor and in the environmental stability thereof are considerably dependent not only on the charge generation layer and the charge transport layer but also on the undercoat layer, and an undercoat layer showing a low charge accumulation in the repeated use is being requested.

Also the undercoat layer plays an important role for preventing defects in the image, performing an important function in suppressing image defects resulting from a defect or a stain in the substrate or from a defect or an unevenness in upper layers such as a charge generation layer.

Particularly in the recent electrophotographic apparatus, a charging apparatus of contact type with reduced ozone generation is employed instead of a corotron, and, in a contact charging process, a localized high electric field applied eventually to a locally deteriorated part of the electrophotographic photoreceptor may generate an electric pinhole, leading to an image defect.

Such pinhole leak may be generated by the aforementioned defect in the electrophotographic photoreceptor itself, but is otherwise generated by a fact that a conductive substance generated in the electrophotographic apparatus is maintained in contact with or penetrates in the electrophotographic photoreceptor thereby facilitating. formation of a conductive path between the contact charging apparatus and the substrate of the electrophotographic photoreceptor. In extreme cases, an extraneous substance mixed from other parts in the electrophotographic apparatus or a dust migrating into the electrophotographic apparatus may lodge in the electrophotographic photoreceptor thereby forming a point of leak from the contact charging apparatus.

Against such drawbacks, there has been employed a method of coating the substrate with a layer containing a conductive fine powder, thereby forming a thicker undercoat layer for concealing defects in the substrate and stabilizing the electrical characteristics.

One method for this purpose is to form an electroconductive layer of conductive powder dispersion type on an aluminum substrate, and to form an undercoat layer thereon. In this case, the conductive layer executes a concealment of the substrate and a resistance regulation, and the undercoat layer executes a blocking (charge injection control) function.

Also in another method, a layer of a conductive powder dispersion, having a blocking (charge injection control) function and a resistance regulating function is coated on the substrate and is used as an undercoat layer having functions of both the blocking (charge injection control) layer and the resistance regulating layer.

In comparison with the former method of forming the undercoat layer, the latter method of forming the undercoat layer can dispense with one layer, thereby simplifying the producing process of the electrophotographic photoreceptor and reducing the cost thereof.

However, in case of the latter undercoat layer, it is necessary to incorporate the function of resistance control and the function of the charge injection control into a single layer, thus resulting in a significant restriction in the material design.

Also from the standpoint of leak prevention, the undercoat layer is more effective with a larger thickness and is required to have a thickness of 10 μm or larger, and, in a thick layer, the resistance has to be lowered in order to obtain satisfactory electrical characteristics, but, in such case, the layer tends to show a lowered charge blocking ability, thus increasing a fog as an image defect.

Therefore the latter undercoat layer realized with a conductive titanium oxide powder or the like is restricted to a film thickness within a range of one to several micrometers, and, with the already known materials, it has not been possible to provide an undercoat layer capable of meeting all the characteristics required for the electrophotographic photoreceptor, such as an improvement in the leak resistance, stabilized electrical characteristics and a reduced fog level, in a thickened layer.

Particularly recently, an electrophotographic photoreceptor of a long service life is strongly expected because of the increased concern for the environmental issues, and improvements in the electrical characteristics and the stability of image quality are essential in a long-term repeated use.

There are also proposed methods of including additives such as an electron accepting substance or an electron transporting substance in the undercoat layer (for example, JP-A Nos. 7-175249, 844097 and 9-197701).

However, even with these methods, it has not been possible to provide an undercoat layer capable of meeting all the characteristics required for the electrophotographic photoreceptor, such as an improvement in the leak resistance, stabilized electrical characteristics and a reduced fog level, in a thickened layer.

In consideration of the foregoing, the present invention is to provide an electrophotographic photoreceptor of excellent electrical characteristics with little variation in the electrical characteristics and little generation of image defects and not causing an image defect such as a pinhole leak even after repeated use, and an electrophotographic cartridge and an electrophotographic apparatus utilizing the same.

### SUMMARY OF THE INVENTION

The present invention, in a first aspect, provides an electrophotographic photoreceptor including a conductive substrate, and at least an undercoat layer and a photosensitive layer thereon, wherein the undercoat layer contains metal oxide fine particles to which an electron acceptor compound is attached.

The present invention, in a second aspect, provides an electrophotographic cartridge including at least an electrophotographic photoreceptor containing a conductive substrate, and at least an undercoat layer and a photosensitive layer thereon, in which the undercoat layer contains metal oxide fine particles to which an electron acceptor compound is attached, and a contact charging apparatus maintained in contact with the electrophotographic photoreceptor for charging the same.

The present invention, in a third aspect, provides an electrophotographic apparatus including at least an electrophotographic photoreceptor containing a conductive substrate, and at least an undercoat layer and a photosensitive layer thereon, in which the undercoat layer contains metal oxide fine particles to which an electron acceptor compound is attached, and a contact charging apparatus maintained in contact with the electrophotographic photoreceptor for charging the same.

The present invention, in a fourth aspect, provides an electrophotographic apparatus including at least an electrophotographic photoreceptor containing a conductive substrate, and at least an undercoat layer and a photosensitive layer thereon, in which the undercoat layer contains metal oxide fine particles to which an electron acceptor compound is attached, and an intermediate transfer apparatus for transferring an image formed on the electrophotographic photoreceptor.

### BRIEF DESCRIPTION OF THE DRAWINGS

Preferred embodiments of the present invention will be described in detail based on the following figures, wherein:

FIG. 1 is a schematic cross-sectional view showing an electrophotographic photoreceptor of the present invention;

FIG. 2 is a schematic view of an electrophotographic apparatus of the invention;

FIG. 3 is a schematic view of another electrophotographic apparatus of the invention;

FIG. 4 is a schematic view of still another electrophotographic apparatus of the invention; and

FIG. 5 is a schematic view of an electrophotographic cartridge of the invention.

### DETAILED DESCRIPTION OF THE PREFERRED EMBODIMENTS

The present inventors, as a result of intensive investigations, have found that the aforementioned drawbacks can be resolved by an electrophotographic photoreceptor having at least an undercoat layer and a photosensitive layer on a conductive substrate in which the undercoat layer includes metal oxide fine particles to which an electron acceptor compound is attached.

More specifically, an electrophotographic photoreceptor of the invention, including, on a conductive substrate, an undercoat layer containing metal oxide fine particles to which an electron acceptor compound is attached, can provide stable electrical characteristics even in a long-term use and can sufficiently prevent a leak generation even when it is stuck by an extraneous substance generated from components around the electrophotographic photoreceptor or a dust migrating from the exterior of the electrophotographic apparatus. It is therefore possible to obtain a sufficiently satisfactory image quality over a prolonged period.

The reason for the aforementioned effects in the invention is not yet clarified, but is estimated by the present inventors as follows.

An undercoat layer containing metal oxide particles, when made thicker, can prevent leak generation even when it is stuck by an extraneous substance generated from components around the electrophotographic photoreceptor or a dust migrating from the exterior of the electrophotographic apparatus, but cannot secure a sufficient constancy of the electrical characteristics in a long-term use. This is presumably attributable to a charge accumulation in the undercoat layer or at the interface of the undercoat layer and an upper layer in the course of a long-term repeated use.

In case the undercoat layer contains metal oxide particles to which an electron acceptor compound is attached, it is estimated that such an electron acceptor compound attached to the metal oxide fine particles in the undercoat layer assists a charge transfer at the interface between the undercoat layer and the upper layer, and prevents charge trapping in the undercoat layer thereby avoiding an increase in a retentive potential in a long-term use.

The present inventors have made the present invention based on such findings.

In the following, the present invention will be clarified in detail by a preferred embodiment thereof, occasionally with reference to the accompanying drawings. In the drawings, same or like parts will be represented by same numbers and will not be explained in repetition.

(Electrophotographic Photoreceptor)

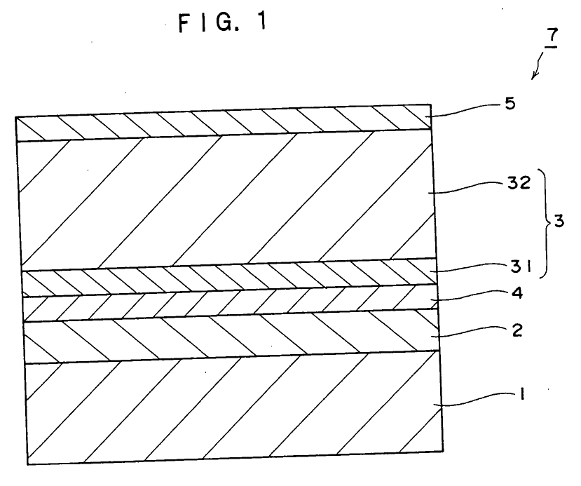

FIG. 1 is a schematic cross-sectional view showing an example of an electrophotographic photoreceptor of the present invention. An electrophotographic photoreceptor 7 has a laminar structure in which, on a conductive substrate 1, an undercoat layer 2, an intermediate layer 4, a photosensitive layer 3 and a overcoat layer 5 are laminated in succession. The electrophotographic photoreceptor 7 shown in FIG. 1 is a photoreceptor of function-separated type, in which the photosensitive layer 3 is constituted of a charge generation layer 31 and a charge transport layer 32.

The conductive substrate 1 is constituted of a metal drum such as of aluminum, copper, iron, stainless steel, zinc or nickel; a base material such as a sheet of paper, plastics or glass evaporated thereon with a metal such as aluminum, copper, gold, silver, platinum, palladium, titanium, nickel-chromium, stainless steel, or indium or a conductive metal compound such as indium oxide or tin oxide; an aforementioned base material laminated with a metal foil or an aforementioned base material rendered electroconductive by coating carbon black, indium oxide, tin oxide, antimony oxide powder, metal powder, or copper iodide dispersed in a binder resin.

The conductive substrate 1 is not limited to a drum shape but can also be a sheet shape or a plate shape. In case the conductive substrate 1 is formed by a metal pipe, the surface thereof may be untreated, or may be subjected in advance to a suitable treatment such as mirror grinding, etching, anodizing, rough grinding, centerless grinding, sand blasting or wet honing.

The undercoat layer 2 is formed by including metal oxide fine particles to which an electron acceptor compound is attached.

The electron acceptor compound may be arbitrarily selected as long as desired properties can be obtained, but a compound having a quinone group can be employed preferably. Also an acceptor compound having an anthraquinone structure can be employed preferably. The compound having the anthraquinone structure includes, in addition to anthraquinone itself, a hydroxyanthraquinone compound, an aminoanthraquinone compound, and an aminohydroxyanthraquinone compound, all of which may be employed preferably. More specifically, anthraquinone, alizarin, quinizarin, anthrarufin, purpurin and the like can be employed particularly preferably.

An addition amount of such an electron acceptor compound may be arbitrarily selected as long as desired characteristics can be obtained, but is preferably 0.01 to 20 weight % with respect to the metal oxide fine particles, more preferably 0.05 to 10 weight %. An addition amount of the electron acceptor compound less than 0.01 weight % is unable to provide a sufficient acceptor property capable of contributing to an improvement in the charge accumulation in the undercoat layer 2, thereby often resulting in a deterioration of constancy such as an increase in the retentive potential in a repeated use.

Also an amount exceeding 20 weight % tends to cause an agglomeration among the metal oxide, whereby the metal oxide becomes incapable of forming a satisfactory electroconductive path in the undercoat layer 2 at the formation thereof, thereby easily resulting not only in a deterioration of constancy such as an increase in the retentive potential in a repeated use but also in an image defect such as a black spot.

The electron acceptor compound can be attached uniformly to the metal oxide fine particles by maintaining the metal oxide fine particles in agitation with a mixer or the like of a high shearing force and dropwise adding the electron acceptor compound, dissolved in an organic solvent, and spraying it together with dry air or nitrogen gas.

The addition or spraying of the electron acceptor compound is preferably executed below the boiling point of the solvent, as the spraying at or above the boiling point of the solvent causes evaporation of the solvent before a uniform agitation is attained, thus resulting in a localized solidification of the electron acceptor compound and hindering a uniform treatment. After the addition or spraying, a drying can be carried out at or above the boiling point of the solvent. Also a uniform attaching can be achieved by agitating the metal oxide fine particles in a solvent, dispersing them utilizing an ultrasonic wave, a sand mill, an attriter or a ball mill, then adding a solution of the electron acceptor compound in an organic solvent, executing a refluxing, or agitation or dispersion under the boiling point of the organic solvent, and eliminating the solvent. The solvent can be eliminated by filtration, distilling or drying under heating.

The metal oxide fine particles to which the electron acceptor compound is attached are required to have a powder resistance (volumic resistivity) of about 10² to 10¹¹ Ω·cm, because the undercoat layer 2 is required to have an appropriate resistance for attaining a leak resistance. A resistance of the metal oxide fine particles lower than the lower limit of the aforementioned range may not provide a sufficient leak resistance, while a resistance higher than the upper limit of the aforementioned range may result in an increase in the retentive potential.

The metal oxide fine particles such as titanium oxide, zinc oxide, tin oxide, or zirconium oxide having the aforementioned resistance are employed preferably, and zinc oxide is particularly preferably employed. Also the metal oxide fine particles may be employed as a mixture of two or more kinds which are different for example in the surface treatment or in the particle size.

The metal oxide fine particles preferably have a specific surface area of 10 m²/g or higher. Those having a specific surface area less than 10 m²/g tend to result in a lowered charging property, thus often leading to unsatisfactory electrophotographic characteristics.

The metal oxide fine particles may be subjected to a surface treatment prior to the attaching of the electron acceptor compound. Any surface treating agent capable of providing the desired properties can be employed and selected from known materials. For example, there can be employed a silane coupling agent, a titanate-based coupling agent, an aluminum-based coupling agent or a surfactant. In particular, a silane coupling agent is employed preferably as it provides satisfactory electrophotographic characteristics. Further, a silane coupling agent having an amino group is employed preferably as it provides the undercoat layer 2 with a satisfactory blocking property.

Any silane coupling agent having an amino group capable of providing the electrophotographic photoreceptor with the desired characteristics can be used, and specific examples include γ-aminopropyltriethoxysilane, N-β-aminoethyl)-γ-aminopropyl trimethoxysilane, N-β-aminoethyl)-γ-aminopropylmethyl methoxysilane and N,N-bis(β-hydroxyethyl)-γ-aminopropyl triethoxysilane, but these examples are not restrictive.

The silane coupling agent may be employed in a mixture of two or more kinds. Examples of a silane coupling agent that can be used in combination with the silane coupling agent having an amino group include vinyltrimethoxysilane, γ-methacryloxypropyl-tris(β-methoxyethoxy)silane, β-(3,4-epoxycyclohexyl)ethyl trimetoxysilane, γ-glycidoxypropyl trimethoxysilane, vinyltriacetoxysilane, γ-mercaptopropyltrimethoxysilane, γ-aminopropyltriethoxysilane, N-β-aminoethyl)-γ-aminopropyl trimethoxysilane, N-β-aminoethyl)-γ-minopropylmethyl methoxysilane, N,N-bis(β-hydroxyethyl)-γ-aminopropyl triethoxysilane, and γ-chloropropyltrimethoxysilane, but these examples are not restrictive.

The surface treatment may be executed in any known method, and can be executed by a dry method or a wet method.

In case of a surface treatment with a dry method, a uniform surface treatment can be achieved by maintaining the metal oxide fine particles in agitation with a mixer or the like of a high shearing force and dropwise adding the silane coupling agent, either directly or in a state dissolved in an organic solvent, and spraying it together with dry air or nitrogen gas. The addition or spraying is preferably executed below the boiling point of the solvent, as the spraying at or above the boiling point of the solvent may cause evaporation of the solvent before a uniform agitation is attained, thus resulting in a localized solidification of the silane coupling agent and hindering a uniform treatment. After the addition or spraying, a calcining can be carried out at or above 100° C. The calcining may be executed within an arbitrary range of temperature and time capable of providing desired electrophotographic characteristics.

A uniform treatment in the wet method can be achieved by agitating the metal oxide fine particles in a solvent, dispersing them utilizing an ultrasonic wave, a sand mill, an attriter or a ball mill, then adding a solution of the silane coupling agent in an organic solvent, executing agitation or dispersion, and eliminating the solvent. The solvent can be eliminated by filtration or distillation. After the removal of the solvent, a baking can be carried out at or above 100° C. The baking may be executed within an arbitrary range of temperature and time capable of providing desired electrophotographic characteristics. In the wet method, it is also possible to eliminate the moisture contained in the metal oxide fine particles prior to the addition of the surface treating agent, for example by heating under agitation in a solvent to be used for the surface treatment or by an azeotropic elimination with a solvent.

An amount of the silane coupling agent to the metal oxide fine particles in the undercoat layer 2 may be selected arbitrarily as long as desired electrophotographic characteristics can be obtained.

As the binder resin contained in the undercoat layer 2, any known resin capable of forming a satisfactory film and providing desired characteristics may be utilized, for example a known polymer resinous compound such as an acetal resin including polyvinylbutyral, a polyvinyl alcohol resin, casein, a polyamide resin, a cellulose resin, gelatin, a polyurethane resin, a polyester resin, a methacrylic resin, an acrylic resin, a polyvinyl chloride resin, a polyvinyl acetate resin, a vinyl chloride-vinyl acetate-maleic anhydride resin, a silicone resin, a silicone-alkyd resin, a phenolic resin, a phenol-formaldehyde resin, a melamine resin, or an urethane resin, a charge transporting resin having a charge transport group, or a conductive resin such as polyaniline.

Among these, a resin insoluble in a coating solvent for an upper layer is employed preferably, particularly a phenolic resin, a phenol-formaldehyde resin, a melamine resin, an urethane resin or an epoxy resin.

In a coating liquid for forming the undercoat layer 2, a ratio of the metal oxide fine particles to which the electron acceptor compound is attached and the binder resin can be selected arbitrarily within a range capable of providing desired characteristics for the electrophotographic photoreceptor.

The coating liquid for forming the undercoat layer 2 may further include various additives for the purpose of improving electrical characteristics, an environmental stability and an image quality.

The additives include an electron transporting material, for example a quinone compound such as chloranil or bromoanil, a tetracyanoquinodimethane compound, a fluorenone compound such as 2,4,7-trinitrofluorenone, or 2,4,5,7-tetranitro-9-fluorenone, an oxadiazole compound such as 2-(4-biphenyl)-5-(4-t-butylphenyl)-1,3,4-oxadiazole, 2,5-bis(4-naphthyl)-1,3,4-oxadiazole, or 2,5bis(4-diethylaminophenyl)-1,3,4-oxadiazole, a xanthone compound, a thiophene compound, or a diphenoquinone compound such as 3,3′,5,5′-tetra-tbutyldiphenoquinone; an electron transporting pigment of condensed polycyclic type or azo type; a zirconium chelate compound; a titanium chelate compound; an aluminum chelate compound; a titanium alkoxide; an organic titanium compound; a silane coupling agent; and other known materials.

The silane coupling agent is employed for the surface treatment of zinc oxide, but may also be used as an additive in the coating liquid. Examples of the silane coupling agent employed herein include vinyltrimethoxysilane, γ-methacryloxypropyl-tris(β-methoxyethoxy)silane, β-(3,4-epoxycyclohexyl)ethyl trimethoxysilane, γ-glycidoxypropyl trimethoxysilane, vinyltriacetoxysilane, γ-nercaptopropyltrimethoxysilane, γ-aminopropyltriethoxysilane, N-β-aminoethyl)-γ-aminopropyl trimethoxysilane, N-β-(aminoethyl)-γ-aminopropylmethyl methoxysilane, N,N-bis(β-hydroxyethyl)-γ-aminopropyl triethoxysilane, and γ-chloropropyltrimethoxysilane. Also examples of the zirconium chelate compound include zirconium butoxdie, ethyl zirconium acetacetate, zirconium triethanolamine, acetylacetonate zirconium butoxide, ethyl acetacetate zirconium butoxide, zirconium acetate, zirconium oxalate, zirconium lactate, zirconium phosphonate, zirconium octanoate, zirconium naphthenoate, zirconium laurate, zirconium stearate, zirconium isostearate, zirconium methacrylate butoxide, zirconium stearate butoxide, and zirconium isostearate butoxide.

Examples of the titanium chelate compound include tetraisopropyl titanate, tetra-n-butyl titanate, butyl titanate dimer, tetra(2-ethylhexyl) titanate, titanium acetylacetonate, polytitanium acetylacetonate, titanium octyleneglycolate, titanium lactate ammonium salt, titanium lactate, titanium lactate ethyl ester, titanium triethanolaminate, and polyhydroxytitanium stearate.

Examples of the aluminum chelate compound include aluminum isopropylate, monobutoxyaluminum diisopropylate, aluminum butyrate, diethylacetacetate aluminum diisopropylate, and aluminum tris(ethyl acetacetate).

These compounds may be employed singly, or as a mixture or a polycondensate of plural compounds.

A solvent for preparing the coating liquid for the undercoat layer can be arbitrarily selected from known organic solvents, such as an alcohol, an aromatic solvent, a halogenated hydrocarbon, a ketone, a ketone alcohol, an ether and an ester. For example there can be employed an ordinary organic solvent such as methanol, ethanol, n-propanol, iso-propanol, n-butanol, benzyl alcohol, methyl cellosolve, ethyl cellosolve, acetone, methyl ethyl ketone, cyclohexanone, methyl acetate, ethyl acetate, n-butyl acetate, dioxane, tetrahydrofuran, methylene chloride, chloroform, chlorobenzene or toluene.

Also such solvent employed for dispersion may be employed singly or in a mixture of two or more kinds. In case of a mixture, there may be employed any solvents that can dissolve the binder resin in a mixed solvent.

For dispersing the metal oxide fine particles, there can be employed any known method utilizing, for example, a roll mill, a ball mill, a vibrating ball mill, an attriter, a sand mill, a colloid mill, or a paint shaker. Also for coating the undercoat layer 2, there can be employed an ordinary method such as a blade coating method, a wired bar coating method, a spray coating method, an dip coating method, a bead coating method, an air knife coating method or a curtain coating method.

The coating liquid for forming the undercoat layer, thus prepared, is used to form an undercoat layer 2 on the conductive substrate 1.

The undercoat layer 2 preferably has a Vickers strength of 35 or higher. Also the undercoat layer 2 has a thickness of 15 μm or larger, more preferably 20 to 50 μm.

A thickness of the undercoat layer 2 less than 15 μm may be unable to provide a sufficient leak resistance, while a thickness exceeding 50 μm may tend to show a residual potential in a long-term use, thereby resulting in an abnormal image density.

The undercoat layer 2 is regulated, for the purpose of preventing moire patterns, to a surface roughness corresponding to ¼n (n being a refractive index of the upper layer) to ½ of a wavelength λ of an exposing laser to be employed. For the purpose of roughness regulation, particles, for example, of a resin may be added in the undercoat layer 2. The resin particles may be, for example, silicone resin particles or crosslinked PMMA resin particles.

Also for regulating the surface roughness, the undercoat layer 2 may be subjected to a polishing process. For the polishing, there can be utilized a buff polishing, a sand blasting, a wet honing or a grinding process.

Between the undercoat layer 2 and the photosensitive layer 3, an intermediate layer 4 may be provided for improving electrical characteristics, image quality, constancy of image quality, and adhesion of the photosensitive layer.

The intermediate layer 4 can be formed by a polymer resinous compound such as an acetal resin including polyvinylbutyral, a polyvinyl alcohol resin, casein, a polyamide resin, a cellulose resin, gelatin, a polyurethane resin, a polyester resin, a methacrylic resin, an acrylic resin, a polyvinyl chloride resin, a polyvinyl acetate resin, a vinyl chloride-vinyl acetate-maleic anhydride resin, a silicone resin, a silicone-alkyd resin, a phenol-formaldehyde resin, or a melamine resin, or a organometallic compound containing zirconium, titanium, aluminum, manganese, or silicon atom.

These compounds may be employed singly or as a mixture or a polycondensate of plural compounds. Among these, a organometallic compound containing zirconium or silicon shows an excellent performance such as a low residual potential, little environmental potential change, and little potential change in repeated uses.

Examples of the silicon compound include vinyltrimethoxysilane, γ-methacryloxypropyl-tris(β-methoxyethoxy)silane, β-(3,4-epoxycyclohexyl)ethyl trimethoxysilane, γ-glycidoxypropyl trimethoxysilane, vinyltriacetoxysilane, γ-mercaptopropyltrimethoxysilane, γ-aminopropyltriethoxysilane, N-β-aminoethyl)-γ-aminopropyl trimethoxysilane, N-β-aminoethyl)-γ-aminopropylmethyl methoxysilane, N,N-bis(β-hydroxyethyl)-γ-aminopropyl triethoxysilane, and γ-chloropropyltrimethoxysilane.

Among these, a particularly preferred silicon compound is a silane coupling agent such as vinyltriethoxysilane, vinyltris(2-methoxyethoxysilane), 3-methacryloxypropyl trimethoxysilane, 3-glycidoxypropyl trimethoxysilane, 2-(3,4-epoxycyclohexyl)ethyl trimethoxysilane, N-2-aminoethyl)-3-aminopropyl trimethoxysilane, N-2-aminoethyl)-3-aminopropylmethyl dimethoxysilane, 3-aminopropyltriethoxysilane, N-phenyl-3-aminopropyltrimethoxysilane, 3-mercaptopropyl trimethoxysilane or 3-chloropropyltrimethoxysilane.

Examples of the organic zirconium compound include zirconium butoxdie, ethyl zirconium acetacetate, zirconium triethanolamine, acetylacetonate zirconium butoxide, ethyl acetacetate zirconium butoxide, zirconium acetate, zirconium oxalate, zirconium lactate, zirconium phosphonate, zirconium octanoate, zirconium naphthenoate, zirconium laurate, zirconium stearate, zirconium isostearate, zirconium methacrylate butoxide, zirconium stearate butoxide, and zirconium isostearate butoxide.

Examples of the organic titanium compound include tetraisopropyl titanate, tetra-n-butyl titanate, butyl titanate dimer, tetra(2-ethylhexyl) titanate, titanium acetylacetonate, polytitanium acetylacetonate, titanium octyleneglycolate, titanium lactate ammonium salt, titanium lactate, titanium lactate ethyl ester, titanium triethanolaminate, and polyhydroxytitanium stearate.

Examples of the organic aluminum compound include aluminum isopropylate, monobutoxyaluminum diisopropylate, aluminum butyrate, diethylacetacetate aluminum diisopropylate, and aluminum tris(ethyl acetacetate).

The intermediate layer 4 functions as an electrical blocking layer, in addition to an improvement in the coating property of the upper layer, but, in case of an excessively large thickness, may show an excessively strong electrical barrier leading to a desensitization or a potential increase in repeated uses. Therefore, the intermediate layer 4, in case it is provided, is formed with a thickness of 0.1 to 5 μm.

A charge generation layer 31 constituting the photosensitive layer 3 is formed by a vacuum evaporation of a charge generation material, or by dispersing and coating such charge generation material together with an organic solvent and a binder resin.

In case of forming the charge generation layer 31 by a dispersion coating, the charge generation layer 31 can be formed by dispersing the charge generation material together with an organic solvent, a binder resin and additives and coating thus obtained dispersion.

In the present invention, any known charge generation material may be employed.

For an infrared light, there is employed a phthalocyanine pigment, squalirium, a bisazo pigment, a trisazo pigment, perylene, or dithioketopyrrolopyrrole, and, for a visible light, there is employed a polycyclic condensate pigment, a bisazo pigment, perylene, trigonal selenium or dye-sensitized zinc oxide particles.

Among these, a phthalocyanine pigment or an azo pigment is employed as a preferred charge generation material capable of providing a particularly excellent performance. The phthalocyanine pigment allows to obtain an electrophotographic photoreceptor having a particularly high sensitivity and excellent in a stability in repeated uses.

The phthalocyanine pigment or azo pigment usually has several crystalline forms, any of which may be employed as long as electrophotographic characteristics meeting the purpose can be obtained. Particularly preferable phthalocyanine pigment includes chlorogallium phthalocyanine, dichlorotin phthalocyanine, hydroxygallium phthalocyanine, metal-free phthalocyanine, oxytitanyl phthalocyanine and chloroindium phthalocyanine.

The phthalocyanine pigment crystals can be prepared by a mechanical dry crushing of a phthalocyanine pigment prepared by a known process, for example with an automatic mortar, a planet mill, a vibrating mill, a CF mill, a roller mill, a sand mill or a kneader, or, after the dry crushing, by a wet crushing with a solvent in a ball mill, a mortar, a sand mill, or a kneader.

A solvent to be employed in the aforementioned process can be an aromatic solvent (such as toluene or chlorobenzene), an amide (such as dimethylformamide or N-methylpyrrolidone), an aliphatic alcohol (such as methanol, ethanol, or butanol), an aliphatic polyhydric alcohol (such as ethylene glycol, glycerin, or polyethylene glycol), an aromatic alcohol (such as benzyl alcohol or phenethyl alcohol), an ester (an ethyl acetate or butyl acetate), a ketone (such as acetone or methyl ethyl ketone), dimethylsulfoxide, an ether (such as diethyl ether or tetrahydrofuran), a mixture of plural solvents or a mixture of water and the aforementioned organic solvent.

The solvent to be employed is used within a range of 1 to 200 parts by weight, preferably 10 to 100 parts by weight, with respect to 1 part by weight of the pigment crystals. The process is executed within a temperature range from −20° C. to the boiling temperature of the solvent, preferably −10° C. to 60° C. Also at the crushing, an auxiliary crushing agent such as salt or sodium sulfate may be employed. The auxiliary crushing agent may be employed in an amount of 0.5 to 20 times, preferably 1 to 10 times with respect to the pigment.

Also the phthalocyanine pigment crystals prepared by a known method may be subjected to a crystal control by an acid pasting or an acid pasting combined with a dry or wet crushing as mentioned above. An acid to be employed in acid pasting is preferably sulfuric acid of a concentration of 70 to 100%, preferably 95 to 100%, and a dissolution temperature is selected within a range of −20 to 100° C., poreferably −10 to 60° C. An amount of the concentrated sulfuric acid is selected, with respect to the weight of the phthalocyanine pigment crystals, within a range of 1 to 100 times, preferably 3 to 50 times. As a crystallizing solvent, water or a mixture of water and an organic solvent is employed with an arbitrary amount. A crystallizing temperature is not particularly restricted, but a cooling with ice or the like is preferable in order to avoid heat generation.

A binder resin to be employed in the charge generation layer 31 can be selected from a wide range of insulating resins. It may also be selected from an organic photoconductive polymer, such as poly-N-vinylcarbazole, polyvinylanthracene, polyvinylpyrene or polysilane.

Examples of a preferred binder resin include an insulating resin such as a polyvinylacetal resin, a polyarylate resin (such as a polycondensate of bisphenol-A and phthalic acid), a polycarbonate resin, a polyester resin, a phenoxy resin, a vinyl chloride-vinyl acetate copolymer, a polyamide resin, an acrylic resin, a polyacrylamide resin, a polyvinylpyridine resin, a cellulose resin, an urethane resin, an epoxy resin, casein, a polyvinyl alcohol resin, or a polyvinylpyrrolidone resin, but these examples are not restrictive. These binder resins may be employed singly or in a mixture of two or more kinds. Among these, a polyvinylacetal resin can be employed particularly preferably.

In a coating liquid for forming the charge generation layer, a composition ratio (weight ratio) of the charge generation material and the binder resin is preferably within a range of 10:1 to 1:10. A solvent for regulating the coating liquid may be arbitrarily selected from known organic solvents, such as an alcohol, an aromatic solvent, a halogenated hydrocarbon, a ketone, a ketone alcohol, an ether and an ester. For example there can be employed an ordinary organic solvent such as methanol, ethanol, n-propanol, iso-propanol, n-butanol, benzyl alcohol, methyl cellosolve, ethyl cellosolve, acetone, methyl ethyl ketone, cyclohexanone, methyl acetate, ethyl acetate, n-butyl acetate, dioxane, tetrahydrofuran, methylene chloride, chloroform, chlorobenzene or toluene.

Also such solvent employed for dispersion may be employed singly or in a mixture of two or more kinds. In case of a mixture, there may be employed any solvents that can dissolve the binder resin as a mixed solvent.

For dispersing the charge generation material, there can be employed any known method utilizing for example a roll mill, a ball mill, a vibrating ball mill, an attriter, a sand mill, a colloid mill, or a paint shaker. Also for coating method for forming the charge generation layer, there can be employed an ordinary method such as a blade coating method, a wired bar coating method, a spray coating method, a dip coating method, a bead coating method, an air knife coating method or a curtain coating method.

Also at the dispersion, a particle size of 0.5 μm or less, preferably 0.3 μm or less and more preferably 0.15 μm or less is effective for attaining a high sensitivity and a high stability.

Also the charge generation material may be subjected to a surface treatment for the purpose of improving the stability of the electrical characteristics and preventing the image defect. The surface treatment may be achieved with a coupling agent, but it is not restrictive.

Examples of the coupling agent employed in the surface treatment include a silane coupling agent such as vinyltrimethoxysilane, γ-methacryloxypropyl-tris(β-methoethoxy)silane, β-(3,4-epoxycylohexyl)ethyl trimetoxysilane, γ-glycidoxypropyl trimethoxysilane, vinyltriacetoxysilane, γ-mercaptopropyltrimethoxysilane, γ-aminopropyltriethoxysilane, N-β-(aminoethyl)-γ-aminopropyl trimethoxysilane, N-β-(aminoethyl)-γ-aminopropylmethyl methoxysilane, N,N-bis(β-hydroxyethyl)-γ-aminopropyl triethoxysilane, or γ-chloropropyltrimethoxysilane.

Among these, a particularly preferred silane coupling agent is vinyltriethoxysilane, vinyltris(2-methoxyethoxysilane), 3-methacryloxypropyl trimethoxysilane, 3-glycidoxypropyl trimethoxysilane, 2-(3,4-epoxycyclohexyl)ethyl trimethoxysilane, N-2-(aminoethyl)-3-aminopropyl trimethoxysilane, N-2-aminoethyl)-3-aminopropylmethyl dimethoxysilane, 3-aminopropyltriethoxysilane, N-phenyl-3-aminopropyltrimethoxysilane, 3-mercaptopropyl trimethoxysilane or 3-chloropropyltrimethoxysilane.

Also there can be employed an organic zirconium compound such as zirconium butoxdie, ethyl zirconium acetacetate, zirconium triethanolamine, acetylacetonate zirconium butoxide, ethyl acetacetate zirconium butoxide, zirconium acetate, zirconium oxalate, zirconium lactate, zirconium phosphonate, zirconium octanoate, zirconium naphthenoate, zirconium laurate, zirconium stearate, zirconium isostearate, zirconium methacrylate butoxide, zirconium stearate butoxide, or zirconium isostearate butoxide.

Also there can be employed an organic titanium compound such as tetraisopropyl titanate, tetra-n-butyl titanate, butyl titanate dimer, tetra(2-ethylhexyl) titanate, titanium acetylacetonate, polytitanium acetylacetonate, titanium octyleneglycolate, titanium lactate ammonium salt, titanium lactate, titanium lactate ethyl ester, titanium triethanolaminate, or polyhydroxytitanium stearate, or an organic aluminum compound such as aluminum isopropylate, monobutoxyaluminum diisopropylate, aluminum butyrate, diethylacetacetate aluminum diisopropylate, or aluminum tris(ethyl acetacetate).

Also in the coating liquid for the charge generation layer, various additives may be added for the purposes of improving electrical characteristics and image quality.

The additives include an electron transporting material, for example a quinone compound such as chloranil, bromoanil or anthraquinone, a tetracyanoquinodimethane compound, a fluorenone compound such as 2,4,7-trinitrofluorenone, or 2,4,5,7-tetranitro-9-fluorenone, an oxadiazole compound such as 2-(4-biphenyl)-5-(4-t-butylphenyl)-1,3,4-oxadiazole, 2,5-bis(4-naphthyl)-1,3,4-oxadiazole, or 2,5-bis(4-diethylaminophenyl)-1,3,4-oxadiazole, a xanthone compound, a thiophene compound, or a diphenoquinone compound such as 3,3′,5,5′-tetra-t-butyldiphenoquinone; an electron transporting pigment of condensed polycyclic type or azo type; a zirconium chelate compound; a titanium chelate compound; an aluminum chelate compound; a titanium alkoxide compound; an organic titanium compound; a silane coupling agent; and other known materials.

Examples of the silane coupling agent include vinyltrimethoxysilane, γ-methacryloxypropyl-tris(β-methoxyethoxy)silane, β-(3,4-epoxycyclohexyl)ethyl trimethoxysilane, γ-glycidoxypropyl trimethoxysilane, vinyltriacetoxysilane, γ-mercaptopropyltrimethoxysilane, γ-aminopropyltriethoxysilane, N-β-aminoethyl)-γ-aminopropyl trimethoxysilane, N-β-amonoethyl)-γ-aminopropylmethyl methoxysilane, N,N-bis(β-hydroxyethyl)-γ-aminopropyl triethoxysilane, and γ-chloropropyltrimethoxysilane.

Also examples of the zirconium chelate compound include zirconium butoxide, ethyl zirconium acetacetate, zirconium triethanolamine, acetylacetonate zirconium butoxide, ethyl acetacetate zirconium butoxide, zirconium acetate, zirconium oxalate, zirconium lactate, zirconium phosphonate, zirconium octanoate, zirconium naphthenoate, zirconium laurate, zirconium stearate, zirconium isostearate, zirconium methacrylate butoxide, zirconium stearate butoxide, and zirconium isostearate butoxide.

Examples of the titanium chelate compound include tetraisopropyl titanate, tetra-n-butyl titanate, butyl titanate dimer, tetra(2-ethylhexyl) titanate, titanium acetylacetonate, polytitanium acetylacetonate, titanium octyleneglycolate, titanium lactate ammonium salt, titanium lactate, titanium lactate ethyl ester, titanium triethanolaminate, and polyhydroxytitanium stearate.

Examples of the aluminum chelate compound include aluminum isopropylate, monobutoxyaluminum diisopropylate, aluminum butyrate, diethylacetacetate aluminum diisopropylate, and aluminum tris(ethyl acetacetate).

These compounds may be employed singly, or as a mixture or a polycondensate of plural compounds.

Also for forming the charge generation layer 31, there can be employed an ordinary method such as a blade coating method, a wired bar coating method, a spray coating method, a dip coating method, a bead coating method, an air knife coating method or a curtain coating method.

A charge transport material contained in a charge transport layer 32 may be any known charge transport material, of which examples include a hole transport material for example an oxadiazole derivative such as 2,5-bis(p-diethylaminophenyl)-1,3,4-oxadiazole, a pyrazoline derivative such as 1,3,5-triphenyl-pyrazoline or 1-[pyridyl-2)]-3-p-diethylaminostyryl)-5-p-diethylaminostyryl)pyrazoline, an aromatic tertiary amino compound such as triphenylamine, tri(p-methyl)phenylamine, N,N′-bis(3,4-dimethylphenyl)biphenyl-4-amine, dibenzylaniline, or 9,9-dimethyl-N,N′-di(p-tolyl)fluorenone-2-amine, an aromatic tertiary diamino compound such as N,N′-diphenyl-N,N′-bis(3-methylphenyl)-[1,1-biphenyl]-4,4′-diamine, a 1,2,4-triazine derivative such as 3-(4′-dimethylaminophenyl)-5,6-di-4′-methoxyphenyl)-1,2,4-triazine, a hydrazone derivative such as 4-diethylaminobenzaldehyde-1,1-diphenylhydrazone, 4-diphenylaminobenzaldehyde-1,1-diphenylhydrazone, or [p-diethylamino)phenyl](1-naphthyl)phenylhydrazone, a quinazoline derivative such as 2-phenyl-4-styryl-quinazoline, a benzofuran derivative such as 6-hydroxy-2,3-di(p-methoxyphenyl)benzofuran, an α-stilbene derivative such as p-(2,2-diphenylvinyl)-N,N′-diphenylaniline, an enamin derivative, a carbazole derivative such as N-ethylcarbazole, or poly-N-vinylcarbazole and a derivative thereof; an electron transport material, for example a quinone compound such as chloranil, bromoanil or anthraquinone, a tetracyanoquinodimethane compound, a fluorenone compound such as 2,4,7-trinitrofluorenone, or 2,4,5,7-tetranitro-9-fuorenone, an oxadiazole compound such as 2-(4biphenyl)-5-(4-t-butylphenyl)-1,3,4-oxadiazole, 2,5-bis(4-naphthyl)-1,3,4-oxadiazole, or 2,5-bis(4-diethylaminophenyl)-1,3,4-oxadiazole, a xanthone compound, a thiophene compound, or a diphenoquinone compound such as 3,3′,5,5′-tetra-t-butyldiphenoquinone; or a polymer having a group formed from the aforementioned compounds in a main chain or a side chain.

Such charge transport material may be employed singly or in a combination of two or more kinds, but is preferably those represented by following structural formulas (A) to (C) in terms of mobility. 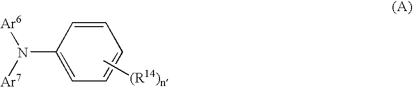
wherein, in the formula (A), R¹⁴ represents a methyl group; n′ represents an integer of 0 to 2; Ar⁶ and Ar⁷ each represents a substituted or non-substituted aryl group, —C(R¹⁸)═C(R¹⁹)(R²⁰), or —CH═CH—CH═C(Ar)₂, in which a substituent is a halogen atom, an alkyl group with 1 to 5 carbon atoms, an alkoxy group with 1 to 5 carbon atoms or a substituted amino group substituted with an alkyl group with 1 to 3 carbon atoms, Ar represents a substituted or non-substituted aryl group, R¹⁸, R¹⁹ and R²⁰ each represents a hydrogen atom, a substituted or non-substituted alkyl group, or a substituted or non-substituted aryl group: 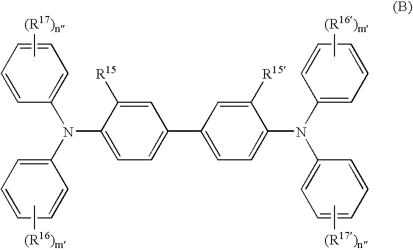
wherein, in the formula (B), R¹⁵ and R^{15′} may be mutually same or different and each represents a hydrogen atom, a halogen atom, an alkyl group with 1 to 5 carbon atoms, or an alkoxy group with 1 to 5 carbon atoms; R¹⁶, R^{16′}, R¹⁷ and R^{17′} may be mutually same or different and each represents a hydrogen atom, a halogen atom, an alkyl group with 1 to 5 carbon atoms, an alkoxy group with 1 to 5 carbon atoms, an amino group substituted with an alkyl group with 1 to 2 carbon atoms, a substituted or non-substituted aryl group, —C(R¹⁸)═C(R¹⁹)(R²⁰), or —CH═CH—CH═C(Ar′)₂, in which Ar′ represents a substituted or non-substituted aryl group, and R¹⁸, R¹⁹ and R²⁰ each represents a hydrogen atom, a substituted or non-substituted alkyl group or a substituted or non-substituted aryl group; and m′ and n′ each represents an integer of 0 to 2: and 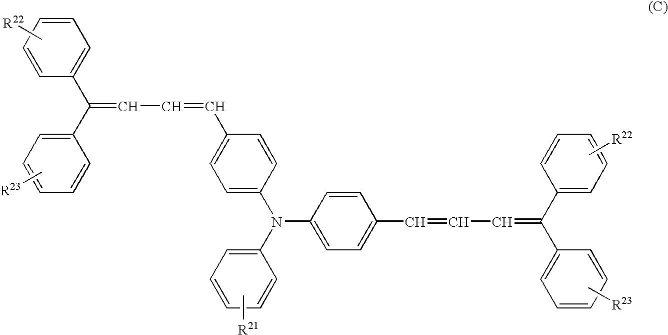
wherein, in the formula (C), R²¹ represents a hydrogen atom, an alkyl group with 1 to 5 carbon atoms, an alkoxy group with 1 to 5 carbon atoms, a substituted or non-substituted aryl group, or —CH═CH—CH═C(Ar″)₂, in which Ar″ represents a substituted or non-substituted aryl group; R²² and R²³ may be mutually same or different, and each represents a hydrogen atom, a halogen atom, an alkyl group with 1 to 5 carbon atoms, an alkoxy group with 1 to 5 carbon atoms, an amino group substituted with 1 to 2 carbon atoms, or a substituted or non-substituted aryl group.

A binder resin of the charge transport layer 32 may be any known resin, but is preferably a resin capable of forming an electroinsulating film.

For example there can be employed an insulating resin such as a polycarbonate resin, a polyester resin, a polyarylate resin, a methacrylic resin, an acrylic resin, a polyvinyl chloride resin, a polyvinylidene chloride resin, a polystyrene resin, an acrylonitrile-styrene copolymer, an acrylonitrile-butadiene copolymer, a polyvinyl acetate resin, a styrene-butadiene copolymer, a vinylidene chloride-acrylonitrile copolymer, a vinyl chloride-vinyl acetate copolymer, a vinyl chloride-vinyl acetate-maleic anhydride copolymer, a silicone resin, a silicone alkyd resin, a phenol-formaldehyde resin, a styrene-alkyd resin, poly-N-carbazole, polyvinylbutyral, polyvinylformal, polysulfon, casein, gelatin, polyvinyl alcohol, ethyl cellulose, phenol resin, polyamide, polyacrylamide, carboxy-methyl cellulose, vinylidene chloride-based polymer wax, or polyurethane, or a polymer charge transport material such as polyvinylcarbazole, polyvinylanthracene, polyvinylpyrene, polysilane or a polyester-based polymer charge transport material disclosed in JP-A Nos. 8-176293 and 8-208820.

Such binder resin may be employed singly or in a mixture of two or more kinds. Such binder resin, which can be employed singly or in a mixture of two or more kinds, is particularly preferably a polycarbonate resin, a polyester resin, a methacrylic resin or an acrylic resin in consideration of a mutual solubility with the charge transport material, a solubility in the solvent and a strength. A composition ratio (weight ratio) of the binder resin and the charge transfer substance can be arbitrarily selected in any case, but attention has to be paid to decreases in the electrical characteristics and in the film strength.

It is also possible to use a polymer charge transport material singly. As the polymer charge transport material, any known material having a charge transport property such as poly-N-vinylcarbazole or polysilane may be employed. In particular, a polyester polymer charge transport material disclosed in JP-A Nos. 8-176293 and 8-208820 is particularly preferable, having a high charge transporting property. The polymer charge transport material may be singly used as the charge transport layer, but it may formed into a film in a mixture with the aforementioned binder resin.

The charge transport layer 32, in case it is a surface layer of the electrophotographic photoreceptor (namely a layer in the photosensitive layer farthest from the conductive substrate), preferably contains lubricating particles (such as silica particles, alumina particles, fluorinated resin particles such as of polytetrafluoroethylene (PTFE), or silicone resin particles) for providing a lubricating property thereby retarding abrasion of the surface layer or avoiding scratches, and improving a cleaning property for a developer deposited on the surface of the photoreceptor. Such lubricating particles may be employed in a mixture of two or more kinds. In particular, fluorinated resin particles can be employed preferably.

For the fluorinated resin particles, one or more kinds are preferably selected from a tetrafluoroethylene resin, a trifluorochloroethylene resin, a hexafluoropropylene resin, a fluorinated vinyl resin, a fluorinated vinylidene resin, a difluorodichloroethylene resin and copolymers thereof, and a tetrafluoroethylene resin or a fluorinated vinylidene resin is particularly preferable.

The aforementioned fluorinated resin preferably has a primary particle size of 0.05 to 1 μm, more preferably 0.1 to 0.5 μm. A primary particle size less than 0.05 μm may tend to result in an agglomeration at or after dispersing operation. Also a size exceeding 1 μm may tend to generate image defects.

In a charge transport layer containing a fluorinated resin, a content of the fluorinated resin in the charge transport layer is preferably 0.1 to 40 weight % with respect to the entire amount of the charge transport layer, particularly preferably 1 to 30 weight %. A content less than 1 weight % may be insufficient for a modifying effect by the dispersed fluorinated resin particles, while a content exceeding 40 weight % may deteriorate an optical transmittance and may cause an increase in the residual potential in repeated uses.

The charge transport layer 32 can be prepared by coating and drying a coating liquid for the charge transport layer, prepared by dissolving the charge transport material, the binder resin and other materials in a suitable solvent.

A solvent to be used for forming the charge transport layer 32 can be an aromatic hydrocarbon solvent such as toluene or chlorobenzene, an aliphatic alcohol solvent such as methanol, ethanol or n-butanol, a ketone solvent such as acetone, cyclohexanone or 2-butanone, a halogenated aliphatic hydrocarbon solvent such as methylene chloride, chloroform or ethylene chloride, a cyclic or linear ether solvent such as tetrahydrofuran, dioxane, ethylene glycol or diethyl ether, or a mixed solvent thereof. A composition ratio of the charge transport material and the binder resin is preferably 10:1 to 1:5.

In the coating liquid for forming the charge transport layer, a small amount of a leveling agent such as silicone oil may be added for improving smoothness of the coated film.

The fluorinated resin can be dispersed in the charge transport layer 32 for example with a roll mill, a ball mill, a vibrating ball mill, an attriter, a sand mill, a high pressure homogenizer, an ultrasonic disperser, a colloid mill, a collision type medialess disperser or a penetration type medialess disperser.

The coating liquid for forming the charge transport layer 32 can be prepared, for example, by dispersing fluorinated resin particles in a solution formed by dissolving the binder resin, the charge transport material and the like in the solvent.

In a process of preparing the coating liquid for forming the charge transport layer 32, the coating liquid is preferably controlled within a temperature range of 0 to 50° C.

For controlling the temperature of the coating liquid at 0-50° C. in the coating liquid manufacturing process, there can be utilized a method of cooling with water, a method of cooling with wind, a method of cooling with a coolant, a method of regulating a room temperature in the manufacturing process, a method of warming with warm water, a method of warming with hot air, a method of warming with a heater, a method of preparing a coating liquid manufacturing facility with a material that does not generate heat easily, a method of preparing a coating liquid manufacturing facility with a material capable of easy heat dissipation, or a method of preparing a coating liquid manufacturing facility with a material capable of easy heat accumulation.

An addition of a small amount of an auxiliary dispersant is also effective for improving the dispersion stability of the dispersed liquid and for preventing agglomeration in forming a coated film. The auxiliary dispersant can be a fluorinated surfactant, a fluorinated polymer, a silicone polymer or a silicone oil. It is also effective to in advance disperse, agitate and mix the fluorinated resin and the aforementioned auxiliary dispersant in a small amount of a dispersing solvent, then agitate and mix thus obtained dispersion with a solution formed by mixing and dissolving the charge transport material, the binder resin and the dispersing solvent, and then executing a dispersion in the aforementioned method.

A coating method for forming the charge transport layer 32 can be, for example, a dip coating method, a fountain extrusion coating method, a spray coating method, a roll coating method, a wire bar coating method, a gravure coating method, a bead coating method, a curtain coating method, a blade coating method or an air knife coating method.

The charge transport layer 32 preferably has a film thickness of 5 to 50 μm, more preferably 10 to 45 μm.

Furthermore, in the electrophotographic photoreceptor of the present invention, an additive such as an antioxidant or a photostabilizer can be added in the photosensitive layer 3, for the purpose of preventing deterioration of the electrophotographic photoreceptor by ozone or an oxidative gas generated in the electrophotographic apparatus or by light or heat.

The antioxidant can be, for example, hindered phenol, hindered amine, paraphenylenediamine, arylalkane, hydroquinone, spirocumaron, spiroindanone, a derivative of the foregoing compounds, an organic sulfur compound or an organic phosphor compound.

Specific examples of the antioxidant, in a phenolic antioxidant, include 2,6-di-t-butyl-4-methylphenol, styrenized phenol, n-octadecyl-3-(3′,5′-di-t-butyl-4′-hydroxyphenyl) propionate, 2,2′-methylene-bis(4-methyl-6-t-butylphenol), 2-t-butyl-6-(3′-t-butyl-5′-methyl-2′-hydroxybenzyl)-4-methylphenyl acrylate, 4,4′-butylidene-bis-(3-methyl-6-t-butylphenol), 4,4′-thio-bis-3-methyl-6-t-butylphenol), 1,3,5-tris(4-t-butyl-3-hydroxy-2,6-dimethylbenzyl) isocyanurate, tetrakis-[methylene-3-(3′,5′-di-t-butyl-4′-hydroxyphenyl) propionate]-methane, and 3,9bis[2-[3-(3-t-butyl-4-hydroxy-5-methylphenyl)propionyloxy]1,1-dimethylethyl]-2,4,8,10-tetraoxaspiro[5,5]undecane.

Those of a hindered amine compound include bis(2,2,6,6-tetramethyl-4-piperidyl) sebacate, bis(1,2,2,6,6-pentamethyl-4-piperidyl) sebacate, 1-[2-[3-(3,5-di-t-butyl-4-hydroxyphenyl)propionyloxy]ethyl]-4-[3-(3,5-di-t-butyl-4-hydroxyphenyl)propionyloxy]-2,2,6,6-tetramethylpiperidine, 8-benzyl-7,7,9,9-tetramethyl-3-octyl-1,3,8-triazaspiro[4,5]undecane-2,4-dione, 4-benzoyloxy-2,2,6,6-tetramethylpiperidine, dimethyl succinate-1-(2-hydroxyethyl)-4-hydroxy-2,2,6,6-tetramethylpiperidine polycondensate, poly[{6-(1,1,3,3-tetramethylbutyl)imino-1,3,5-triazine-2,4-diimyl} {(2,2,6,6-tetramethyl-4-piperidyl)imino}hexamethylene{(2,3,6,6-tetramethyl-4-piperidyl)imino}], 2-(3,5-di-t-butyl-4-hydroxybenzyl)-2-n-butyl malonate bis(1,2,2,6,6-pentamethyl-4-piperidyl), and N,N′-bis(3-aminopropyl)ethylenediamine-2,4bis [N-butyl-N-(1,2,2,6,6-pentamethyl-4-piperidyl)amino]-6-chloro-1,3,5-triazine condensate.

Examples of the organic sulfur-containing antioxidant include dilauryl-3,3′-thiodipropionate, dimyristyl-3,3′-thiodipropionate, distearyl-3,3′-thiodipropionate, pentaerythritol-tetrakis(β-lauryl-thiopropionate), ditridecyl-3,3′-thiodipropionate, and 2-mercaptobenzimidazole.

Also examples of the organic phosphor-containing antioxidant include trisnonylphenyl phosphite, triphenyl phosphite, and tris(2,4-di-t-butylphenyl)phosphite.

The organic sulfur-containing antioxidant or the organic phosphor-containing antioxidant is called a secondary antioxidant which can be used in combination with a primary antioxidant of a phenol type or an amine type to obtain a multiplying effect.

A photostabilizer can be derivatives of benzophenone, benzotriazole, dithiocarbamate, or tetramethylpiperidine.

Examples of the benzophenone-based photostabilizer include 2-hydroxy-4-methoxybenzophenone, 2-hydroxy-4-octoxybenzophenone, and 2,2′-di-hydroxy-4-methoxybenzophenone.

Examples of the benzotriazole-based photostabilizer include 2-(2′-hydroxy-5′-methylphenyl)-benzotriazole, 2-[2′-hydroxy-3′-(3″,4″,5″,6″-tetra-hydrophthalimidemethyl)-5′-methylphenyl]-benzotriazole, 2-(2′-hydroxy-3′-t-butyl-5′-methylphenyl)-5-chlorobenzotriazole, 2-(2′-hydroxy-3′,5′-di-t-butylphenyl)-benzotriazole, 2-(2′-hydroxy-5′-t-octylphenyl)-benzotriazole, and 2-(2′-hydroxy-3′,5′-di-t-amylphenyl)benzotriazole.

Other compounds include 2,4-di-t-butylphenyl-3′,5′-di-t-butyl-4′-hydroxybenzoate and nickel dibutyl-dithiocarbamate.

Also at least an electron-accepting substance may be included for the purposes of improving the sensitivity, reducing the residual potential and reducing a fatigue in repeated uses.

Such electron accepting substance can be, for example, succinic anhydride, maleic anhydride, dibromomaleic anhydride, phthalic anhydride, tetrabromophthalic anhydride, tetracyanoethylene, tetracyanoquinodimethane, o-dinitrobenzene, m-dinitrobenzene, chloranil, dinitroanthraquinone, trinitrofluorenone, picric acid, o-nitrobenzoic acid, p-nitrobenzoic acid or phthalic acid. Among these, particularly preferred are a fluorenone compound, a quinone compound and a benzene derivative having an electron attracting substituent such as Cl, CN or NO₂.

A overcoat layer 5 is used, in an electrophotographic photoreceptor of a laminar structure, for preventing a chemical change in the charge transport layer at charging, and for improving the mechanical strength of the photosensitive layer, thereby further improving resistances to abrasion and scratches of the surface layer.

The overcoat layer 5 can be formed as a resinous cured film containing a curable resin and a charge transporting compound, or a film constituted by including a conductive material in a suitable binder resin, but one containing a charge transport compound is employed more preferably.

The curable resin may be any known resin, but a resin having a crosslinked structure is preferable in consideration of the strength, the electrical characteristics and the constancy of image quality, such as a phenolic resin, an urethane resin, a melamine resin, a diallyl phthalate resin or a siloxane resin.

Among them, a protective layer 5 containing a siloxane resin having a structural unit having a charge-transporting potential and a cross-linking structure is more preferable.

The overcoat layer 5 is preferably a cured film including a compound represented by a following formula (I-1) or (1-2):
F-[D-Si(R²)₍₃₋ₐ₎Qₐ]_{b} Formula(I-1)
wherein, in the formula (I-1), F represents an organic group derived from a photofunctional compound; D represents a flexible subunit; R² represents a hydrogen atom, an alkyl group or a substituted or unsubstituted aryl group; Q represents a hydrolyzable group; a represents an integer of 1-3; and b represents an integer of 1- 4;
F—((X)ₙR¹-ZH)ₘ Formula(I-2)
wherein, in the formula (I-2), F represents an organic group derived from a photofunctional compound; R¹ represents an alkylene group; Z represents an oxygen atom, a sulfur atom, NH, CO₂ or COOH; m represents an integer of 1-4; X represents an oxygen atom or a sulfur atom; and n represents 0 or 1.

In the formulas (I-1) and (I-2), F represents a unit having a photoelectric property, more specifically a photocarrier transporting property, and a structure already known as the charge transport material can be applied. More specifically, there can be utilized a skeleton of a compound having a hole transporting property, such as a triarylamine compound, a benzidine compound, an arylalkane compound, an aryl-sbustituted ethylene compound, a stilbene compound, an anthracene compound, or a hydrazone compound, and a skeleton of a compound having an electron transporting property, such as a quinone compound, a fluorenone compound, a xanthone compound, a benzophenone compound, a cyanovinyl compound, or an ethylene compound.

In the formula (I-1), —Si(R²)₍₃₋ₐ₎Qₐ represents a substituted silicon group having a hydrolysable group, in which the substituted silicon atom causes a mutual crosslinking reaction with a Si group, thereby forming a three-dimensional Si—O—Si bond. Thus, the substituted silicon group serves to form so-called inorganic glass-like network in the overcoat layer 5.

In the formula (I-1), D represents a flexible subunit, more specifically an organic group serving to connect an F portion for realizing a photoelectric property with a substituted silicon group which is directly connected with the three-dimensional inorganic glass-like network and providing the inorganic glass-like network which is hard but brittle with an adequate flexibility and improving the tenacity of the film.

The unit D can be, more specifically, a divalent hydrocarbon group represented by —CₙH₂ₙ—, —CₙH₍₂ₙ₋₂₎— or —CₙH₍₂ₙ₋₄₎—(wherein n represents an integer of 1-15), —COO—, —S—, —O—, —CH₂—C₆H₄—, —N═CH—, —C₆H₄)—(C₆H₄)—, a characteristic group formed by arbitrarily combining these groups, or such characteristic group in which a structural atom is substituted by another substituent.

In the formula (I-1), b is preferably 2 or larger. In case b is 2 or larger, the photofunctional organic silicon compound represented by the general formula (I-1) contains two or more Si atoms, thus becoming easier to form an inorganic glass-like network and increasing the mechanical strength thereof.

Among the formulas (I-1) and (I-2), a compound in which the organic group F is represented by a following formula (I-3) is particularly preferable. A compound represented by the formula (I-3) is a compound having a hole transporting property (hole transport material), and the presence of such compound in the overcoat layer 5 is preferable in terms of improvement in the photoelectric properties and the mechanical properties of the overcoat layer 5. 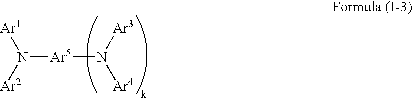
In the formula (I-3), Ar¹ to Ar⁴ each independently represents a substituted or non-substituted aryl group; Ar⁵ represents a substituted or non-substituted aryl group or an arylene group, wherein two to four among Ar¹ to Ar⁵ have a bonding hand represented by -D-Si(R²)₍₃₋ₐ₎Qₐ; D represents a flexible subunit; R² represents a hydrogen atom, an alkyl group, or a substituted or non-substituted aryl group; Q represents a hydrolysable group; and a represents an integer of 1 to 3.

In the formula (I-3), Ar¹ to Ar⁵ are preferably represented by following formulas (I-4) to (I-10).

TABLE 1

| | |
|---|---|
| (I-4) | 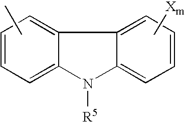 |
| (I-5) | 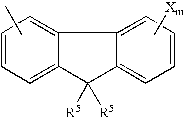 |
| (I-6) | 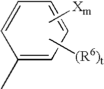 |
| (I-7) | 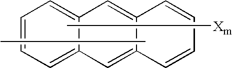 |
| (I-8) | 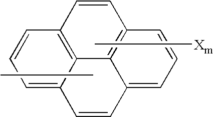 |
| (I-9) | 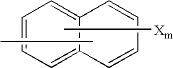 |
| (I-10) | —Ar—(Z′)ₛ—Ar—Xₘ |

In the formulas (I4) to (I-10), R⁵ each independently represents a group selected from a hydrogen atom, an alkyl group with 1 to 4 carbon atoms, a phenyl group substituted with an alkyl group with 1 to 4 carbon atoms or an alkoxy group with 1 to 4 carbon atoms, a non-substituted phenyl group, and an aralkyl group with 7 to 10 carbon atoms; R⁶ represents a group selected from a hydrogen atom, an alkyl group with 1 to 4 carbon atoms, an alkoxy group with 1 to 4 carbon atoms, and a halogen atom; X represents a characteristic group of a structure represented by -D-Si(R²)₍₃₋ₐ₎Qₐ or —(X)ₙR¹-ZH)ₘ described above; m and s each represents 0 or 1; and t represents an integer of 1 to 3.

Throughout the specification, if there are two or more groups represented by the same sign, any two of the groups may be the same as each other or different from each other. Throughout the specification, if there are two or more numbers represented by the same sign, any two of the numbers may be the same as each other or different from each other.

In the formula (I-10), Ar is preferably represented by following formulas (I-11) to (I-12).

TABLE 2

| | |
|---|---|
| (I-11) | 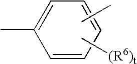 |
| (I-12) | 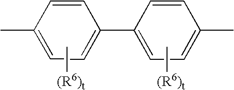 |

In the formulas (I-11) and (I-12), R⁶ has the same meaning as R⁶ mentioned before; and t represents an integer of 1 to 3.

In the formula (I-10), Z′ is preferably represented by following formulas (I-13) to (I-14).

Also in the formulas (I-4) to (I-10), X represents a characteristic group of a structure represented by -D-Si(R²)₍₃₋ₐ₎Qₐ as described before. In such characteristic group, D represents divalent hydrocarbon group represented by —C₁H₂₁—, —CₘH₍₂ₘ₋₂₎— or —CₙH₍₂ₙ₋₄₎—(wherein 1 represents an integer of 1-15, m represents an integer of 2-15 and n represents an integer of 3-15), —N═CH—, —O—, —COO—, —S—, —CH)_{β}—(β representing an integer of 1-10), or a characteristic group represented by the aforementioned formula (I-11) or (I-12) or following formulas (I-13) and (I-14).

TABLE 3

| | |
|---|---|
| (I-13) | 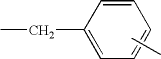 |
| (I-14) | 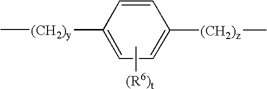 |

In the formula (I-14), y and z each represents an integer of 1 to 5; t represents an integer of 1 to 3; and R⁶ represents, as described before, one selected from a group of a hydrogen atom, an alkyl group with 1 to 4 carbon atoms, an alkoxy group with 1 to 4 carbon atoms, and a halogen atom.

In the formula (I-3), Ar⁵ represents a substituted or non-substituted aryl or arylene group, and, in case of k=0, there is preferred a group corresponding to any of formulas (I-15) to (I-19) shown in Table 4, and, in case of k=1, there is preferred a group corresponding to any of formulas (I-20) to (I-24) shown in Table 5.

TABLE 4

| | |
|---|---|
| (I-15) | 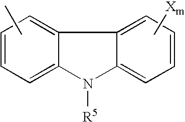 |
| (I-16) | 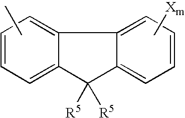 |
| (I-17) | 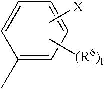 |
| (I-18) | 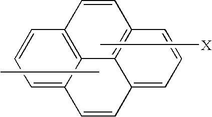 |
| (I-19) | —Ar—(Z)ₛ—Ar—X |

TABLE 5

| | |
|---|---|
| (I-20) | 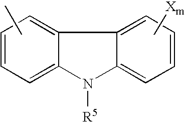 |
| (I-21) | 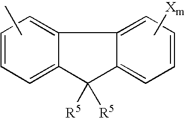 |
| (I-22) | 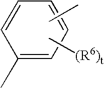 |
| (I-23) | 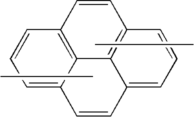 |
| (I-24) | —Ar—(Z)ₛ—Ar— |

In Formulae (I-15) to (I-24), each R⁵ independently represents an atom or a group selected from the group consisting of a hydrogen atom, alkyl groups having 1 to 4 carbons, phenyl groups substituted with an alkyl groups having 1 to 4 carbons or an alkoxy group having 1 to 4 carbons, unsubstituted phenyl groups, and aralkyl groups having 7 to 10 carbons. R⁶ represents an atom or a group selected from the group consisting of a hydrogen atom, alkyl groups having 1 to 4 carbons, alkoxy groups having 1 to 4 carbons, and halogen atoms. s is 0 or 1; and t is an integer of 1 to 3.

Also in case Ar⁵ in the formula (I-3) assumes any of the structures shown by the formulas (I-15) to (I-19) in Table 4 and the formulas (I-20) to (I-24) in Table 5, Z in the formulas (I-19) and (I-24) is preferably one selected from a group of following formulas (I-25) to (I-32).

TABLE 6

| | |
|---|---|
| (I-25) | —(CH₂)_{q}— |
| (I-26) | —(CH₂CH₂O)ᵣ— |
| (I-27) | 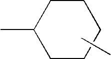 |
| (I-28) | 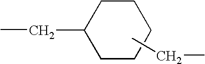 |
| (I-29) | 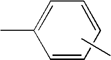 |
| (I-30) | 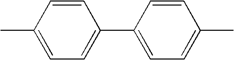 |
| (I-31) | 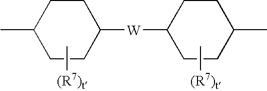 |
| (I-32) | 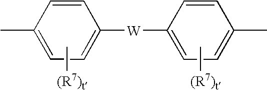 |

In the formulas (I-25) and (I-32), R⁷ each represents one selected from a group of a hydrogen atom, an alkyl group with 1 to 4 carbon atoms, an alkoxy group with 1 to 4 carbon atoms and a halogen atom; W represents a divalent group; q and r each represents an integer of 1 to 10; and t′ represents an integer of 1 to 2.

In the formulas (I-31) and (I-32), W is preferably any one of divalent groups represented by following formulas (I-33) to (I-41). In the formula (I-40), s′ represents an integer of 0 to 3.
—CH₂— (I-33)
—C(CH₃)₂— (I-34)
—O— (I-35)
—S— (I-36)
—C(CF₃)₂— (I-37)
—Si(CH₃)₂— (I-38)

TABLE 7

| | |
|---|---|
| (I-39) | 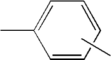 |
| (I-40) | 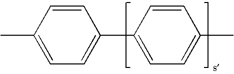 |
| (I-41) | 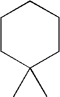 |

Also specific examples of the compound represented by the formula (I-3) are given in JP-A No. 2001-83728, by compounds Nos. 1-274 shown in tables 1-55.

The charge transport compound represented by the general formula (I-1) may be employed singly or in a combination of two or more kinds.

In combination with the charge transport compound represented by the general formula (I-1), for the purpose of further improving the mechanical strength of the cured film, a compound represented by a following formula (II) may be employed.
B—(Si(R²)₍₃₋ₐ₎Qₐ)₂ Formula (II)

In the formula (II), B represents a divalent organic group; R² represents a hydrogen atom, an alkyl group or a substituted or non-substituted aryl group; Q represents a hydrolysable group; and a represents an integer of 1 to 3.

The compound represented by the formula (II) is preferably one represented by following formulas (II-1) to (II-5), but the present invention is not limited to such structures.

In the formulas (II-1) to (II-5), T¹ and T² each independently represents a divalent or trivalent hydrocarbon group that may be branched; A represents a substituted silicon group having a hydrolysable property as explained before; h, i and j each independently represents an integer of 1 to 3. The compound represented by the formulas (II-1) to (II-5) is so selected that a number of A in the molecule is 2 or more.

TABLE 8

| | |
|---|---|
| (II-1) | 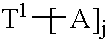 |
| (II-2) | 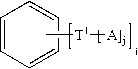 |
| (II-3) | 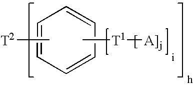 |
| (II-4) | 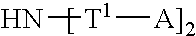 |
| (II-5) | 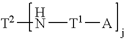 |

In the following, preferred specific examples of the compound represented by the formula (II) are shown by following formulas (III-1) to (III-19) in Tables 9 and 10. In Tables 9 and 10, Me, Et and Pr respectively represent a methyl group, an ethyl group and a propyl group.

TABLE 9

| | |
|---|---|
| (III- 1) | 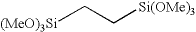 |
| (III- 2) | 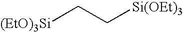 |
| (III- 3) | 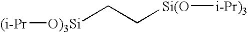 |
| (III- 4) | 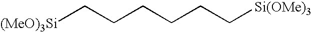 |
| (III- 5) | 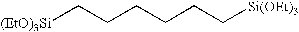 |
| (III- 6) | 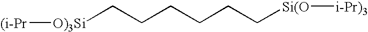 |
| (III- 7) | 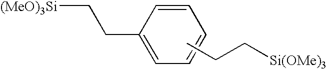 |
| (III- 8) | 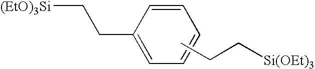 |
| (III- 9) | 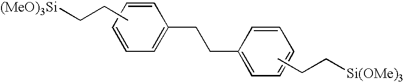 |
| (III- 10) | 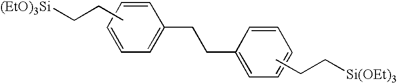 |
| (III- 11) | 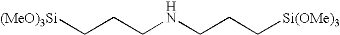 |
| (III- 12) | 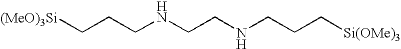 |

TABLE 10

| | |
|---|---|
| (III-13) | (MeO)₂MeSi(CH₂)2SiMe(OMe)₂ |
| (III-14) | (EtO)₂EtSi(CH₂)₂SiEt(OEt)₂ |
| (III-15) | (MeO)₂MeSi(CH₂)₆SiMe(OMe)₂ |
| (III-16) | (EtO)₂EtSi(CH₂)₆SiEt(OEt)₂ |
| (III-17) | (MeO)₂MeSi(CH₂)₁₀SiMe(OMe)₂ |
| (III-18) | (EtO)₂EtSi(CH₂)₁₀SiEt(OEt)₂ |
| (III-19) | MeOMe₂Si(CH₂)₆SiMe₂OMe |

Another compound capable of a crosslinking reaction may be employed in combination with the compound represented by the formula (I-1) or (I-2). Such compound can be a silane coupling agent, or a commercially available silicone hard coating agent.

The silane coupling agent can be vinyltrichlorosilane, vinyltrimethoxysilane, vinyltriethoxysilane, γ-glycidoxypropylmethyl diethoxysilane, γ-glycidoxypropyl triethoxysilane, γ-glycidoxypropyl trimethoxysilane, γ-aminopropyl triethoxysilane, γ-aminopropyl trimethoxysilane, γ-aminopropylmethyl dimethoxysilane, N-β(aminoethyl)γ-aminopropyl triethoxysilane, tetramethoxysilane, methyltrimethoxysilane, or dimethyldimethoxysilane.

The commercially available hard coating agent can be KP-85, CR-39, X-12-2208, X-40-9740, X-41-1007, KNS-5300, X-40-2239 (manufactured by Shin-etsu Chemical Co.), AY42-440, AY42-441 and AY49-208 (manufactured by Dow Corning Toray Silicone Co.).

In the overcoat layer 5, a fluorine atom-containing compound may be added for the purpose of providing a surface lubricating property. An increase in the surface lubricating property can reduce a friction coefficient with a cleaning member and can improve the abrasion resistance. It may also have an effect of preventing deposition of a discharge product, a developer and paper dusts onto the surface of the electrophotographic photoreceptor, thereby extending the service life thereof.

As specific examples of the fluorine-containing compound, it is possible to add a fluorine atom-containing polymer such as polytetrafluoroethylene directly, or to add fine particles of such polymer.

In case the overcoat layer 5 is a cured film formed by the compound represented by the formula (I), it is preferable to add a fluorine-containing compound capable of reacting with alkoxysilane thereby constituting a part of the crosslinked film.

Specific examples of such fluorine atom-containing compound include (tridecafluoro-1,1,2,2-tetrahydrooctyl) triethoxysilane, (3,3,3-trifluoropropyl) trimethoxysilane, 3-heptafluoroisopropoxy)propyl triethoxysilane, 1H,1H,2H,2H-perfluoroalkyl triethoxysilane, 1H,1H,2H,2H-perfluorodecyl triethoxysilane, and 1H, 1H,2H,2H-perfluorooctyl triethoxysilane.

An amount of addition of the fluorine-containing compound is preferably 20 weight % or less. An exceeding amount may cause a defect in the film forming property of the crosslinked cured film.

The aforementioned overcoat layer 5 has a sufficient antioxidation property, but an antioxidant may be added in order to obtain an even stronger antioxidation property.

The antioxidant is preferably a hindered phenol type or a hindered amine type, but it is also possible to employ a known antioxidant such as an organic sulfurbased antioxidant, a phosphite antioxidant, a dithiocarbamate antioxidant, a thiourea antioxidant, or an benzimidazole antioxidant. An amount of addition of the antioxidant is preferably 15 weight % or less, more preferably 10 weight % or less.

Examples of the hindered phenol type antioxidant include 2,6-di-t-butyl-4-methylphenol, 2,5-di-t-butylhydroquinone, N,N′-hexamethylenebis(3,5-di-t-butyl-4-hydroxyhydrocinnamide), 3,5-di-t-butyl-4-hydroxy-benzyl phosphonate diethyl ester, 2,4-bis[(octylthio)methyl]-o-cresol, 2,6-di-t-butyl-4-ethylphenol, 2,2′-methylenebis(4-methyl-6-t-butylphenol), 2,2′-methylenebis(4-ethyl-6-t-butylphenyl), 4,4′-butylidenebis(3-methyl-6-t-butylphenol), 2,5-di-t-amylhydroquinone, 2-t-butyl-6-(3-butyl-2-hydroxy-5-methylbenzyl)-4-methylphenyl acrylate, and 4,4′-butylidenebis(3-methyl-6-t-butylphenol).

In the overcoat layer 5, other known additives employed in film formation may be added, such as a leveling. agent, an ultraviolet absorber, a photostabilizer, a surfactant and the like.

The overcoat layer 5 is formed by coating a mixture of the aforementioned materials and other additives on the photosensitive layer, followed by heating. In this manner a three-dimensional crosslinking curing reaction is induced to form a firm cured film. The heating may be executed at any temperature not influencing the underlying photosensitive layer, but is preferably executed within a range from room temperature to 200° C., particularly from 100° C. to 160° C.

In forming the overcoat layer 5, the crosslinking curing reaction may be executed without a catalyst or with a suitable catalyst. The catalyst can be an acid catalyst such as hydrochloric acid, sulfuric acid, phosphoric acid, formic acid, acetic acid or trifluoroacetic acid; a base such as ammonia or triethylamine; an organic tin compound such as dibutyl tin diacetate, dibutyl tin dioctoate or stannous octoate; an organic titanium compound such as tetra-n-butyl titanate or tetraisopropyl titanate; or an iron salt, a manganese salt, a cobalt salt, a zinc salt, a zirconium salt or an aluminum chelate compound of an organic carboxylic acid.

In the overcoat layer 5, a solvent may be added, if necessary, in order to facilitate coating. More specifically there can be employed water or an ordinary organic solvent such as methanol, ethanol, n-propanol, i-propanol, n-butanol, benzyl alcohol, methyl cellosolve, ethyl cellosolve, acetone, methyl ethyl ketone, cyclohexanone, methyl acetate, n-butyl acetate, dioxane, tetrahydrofuran, methylene chloride, chloroform, dimethyl ether or dibutyl ether. Such solvent may be employed singly or in a mixture of two or more kinds.

In forming the overcoat layer 5, the coating can be executed by an ordinary coating method such as blade coating, Meyer bar coating, spray coating, dip coating, bead coating, air knife coating, or curtain coating.

The overcoat layer 5 has a thickness of 0.5 to 20 μm, preferably 2 to 10 μm.

In the electrophotographic photoreceptor 7, functional layers including the charge generation layer 31 and above have a thickness, for obtaining a high resolution, of 50 μm or less, preferably 40 μm or less. When the functional layers are thin, the combination of the particle-dispersed undercoat layer and the highly strong overcoat layer 5 of the invention becomes particularly effective.

The electrophotographic photoreceptor 7 is not limited to the aforementioned structure. For example, the electrophotographic photoreceptor 7 may be constructed without the intermediate layer 4 and/or the protective layer 5. More specifically, there can be adopted a structure having an undercoat layer 2 and a photosensitive layer 3 on a conductive substrate 1, a structure having an undercoat layer 2, an intermediate layer 4 and a photosensitive layer 3 in succession on a conductive substrate 1, or a structure having an undercoat layer 2, a photosensitive layer 3 and a overcoat layer 5 in succession on a conductive substrate 1.

Also the charge generation layer 31 and the charge transport layer 32 may be laminated in an inverted order. Also the photosensitive layer 3 may have a single-layer structure. In such case, the photosensitive layer may be provided thereon with a overcoat layer, or provided with both an undercoat layer and a overcoat layer. Also an intermediate layer may be provided, as explained in the foregoing, on the undercoat layer.

(Electrophotographic Apparatus)

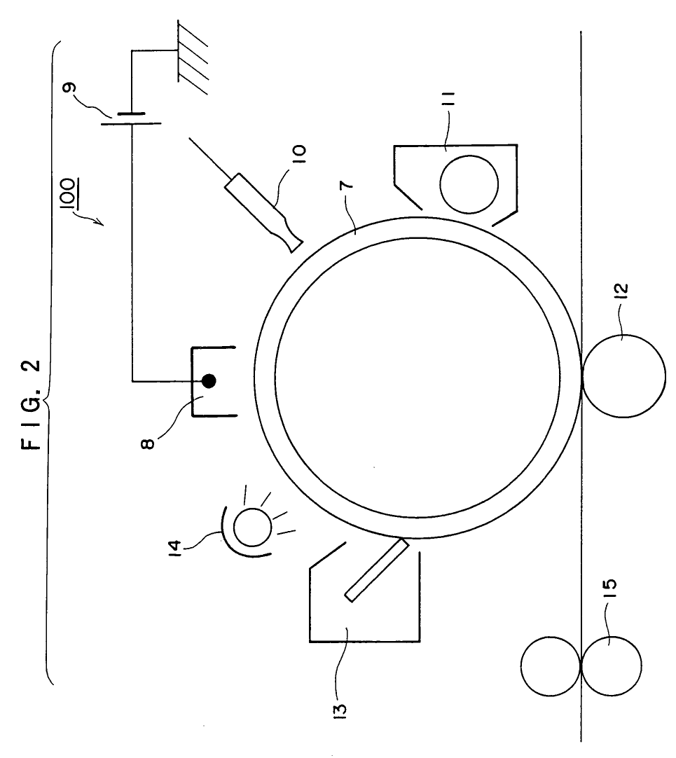

FIG. 2 is a schematic view showing a preferable embodiment of an electrophotographic apparatus of the present invention. An electrophotographic apparatus 100 shown in FIG. 2 is provided with a drum-shaped (cylindrical) electrophotographic photoreceptor 7 of the invention, provided in a rotatable manner. Around the electrophotographic photoreceptor 7, there are provided, along a moving direction of an external periphery thereof, a charging apparatus 8, an exposure apparatus 10, a developing apparatus 11, a transfer apparatus 12, a cleaning apparatus 13 and a charge eliminator (erasing apparatus) 14.

A charging apparatus 8 of a corona charging type is used for charging the electrophotographic photoreceptor 7. The charging apparatus 8 may be constituted of a corotron charger or a scorotron charger. The charging apparatus 8 is connected to a power source 9.

An exposure apparatus 10 exposes the charged electrophotographic photoreceptor 7 to a light, thereby forming an electrostatic latent image thereon.

A developing apparatus 11 develops the electrostatic latent image with a developer to form a toner image. The developer preferably includes toner particles of a volume average particle size of 3 to 9 μm, obtained by a polymerization method.

A transfer apparatus 12 transfers the toner image, developed on the electrophotographic photoreceptor 7, onto a transfer medium.

A cleaning apparatus 13 removes a toner remaining on the electrophotographic photoreceptor 7 after the transfer. The cleaning apparatus 13 preferably has a blade member maintained in contact with the electrophotographic photoreceptor 7 under a linear pressure of 10-150 g/cm.

A charge eliminator (erasing apparatus) 14 erases a retentive charge on the electrophotographic photoreceptor 7. The electrophotographic apparatus 100 is provided with a fixing apparatus 15 for fixing, after the transfer step, the toner image to the transfer medium.

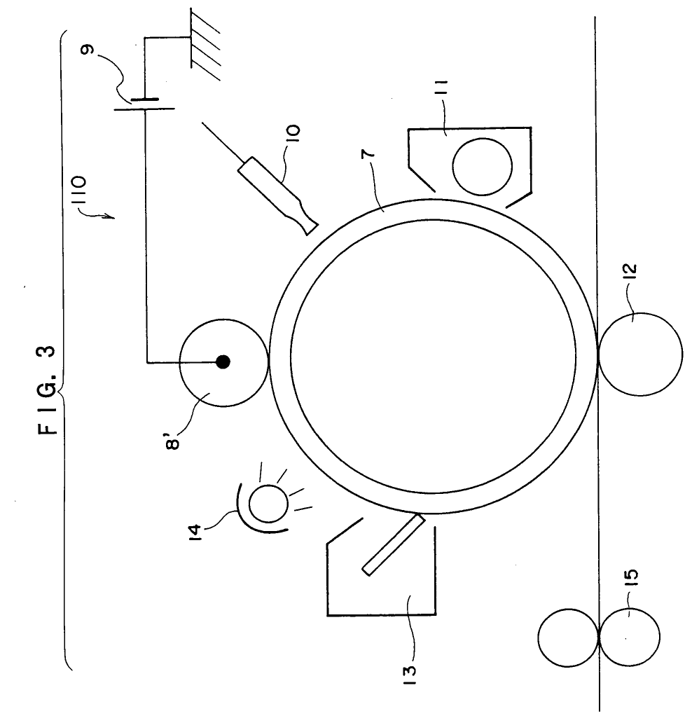

FIG. 3 is a schematic view showing another preferred embodiment of the electrophotographic apparatus of the invention. An electrophotographic apparatus 110 shown in FIG. 3 is similar, in structure, to the electrophotographic apparatus 100 shown in FIG. 2, except that it is equipped with a charging apparatus 8′ for charging the electrophotographic photoreceptor 7 in a contact method. In the electrophotographic apparatus 110 with a contact charging apparatus utilizing a DC voltage superposed with an AC voltage, the electrophotographic photoreceptor 7 can be advantageously employed because of an excellent leak resistance. In this case, the charge eliminator 14 may not be equipped.

In the contact charging method, a charging member of a roller shape, a blade shape, a belt shape, a brush shape or a magnetic brush shape can be utilized. Particularly in case of a roller-shaped or blade-shaped charging member, such charging member may be positioned, with respect to the photoreceptor, in a contact state or in a non-contact state with a certain gap (100 μm or less) thereto.

A roller-shaped, blade-shaped or belt-shaped charging member is constituted of a material regulated to an electrical resistance (10³ to 10⁸ Ω) suitable for a charging member, and may be constituted of a single layer or plural layers.

It can be formed of an elastomer constituted of a synthetic rubber such as urethane rubber, silicone rubber, fluorinated rubber, chloroprene rubber, butadiene rubber, EPDM or epichlorohydrin rubber, or of polyolefin, polystyrene or polyvinyl chloride, blended with an appropriate amount of a conductivity providing material such as conductive carbon, a metal oxide or an ionic conductive material thereby exhibiting an effective electroconductivity as a charging member.

It is also possible to prepare a paint of a resin such as nylon, polyester, polystyrene, polyurethane or silicone, blending therein an appropriate amount of a conductivity providing material such as conductive carbon, a metal oxide or an ionic conductive material and laminating thus obtained paint by an arbitrary method such as a dip, a spraying or a roll coating.

On the other hand, a brush-shaped charging member can be prepared by subjecting already known fibers of acrylic resin, nylon or polyester, rendered electroconductive, to a fluorine impregnating process and then planting such fibers in an already known method. The fluorine impregnating process may be executed after the fibers are formed into a brush-shaped charging member.

The brush-shaped charging member herein includes a roller-shaped member and a charging member having fibers planted on a flat plate, and is not limited to a particular shape. Also a magnetic brush-shaped charging member includes ferrite or magnetite, showing a magnetic power, arranged radially on an external periphery or a cylinder incorporating a multi-pole magnet, and the ferrite or magnetite is preferably subjected to a fluorine impregnating process prior to the formation into a magnetic brush.

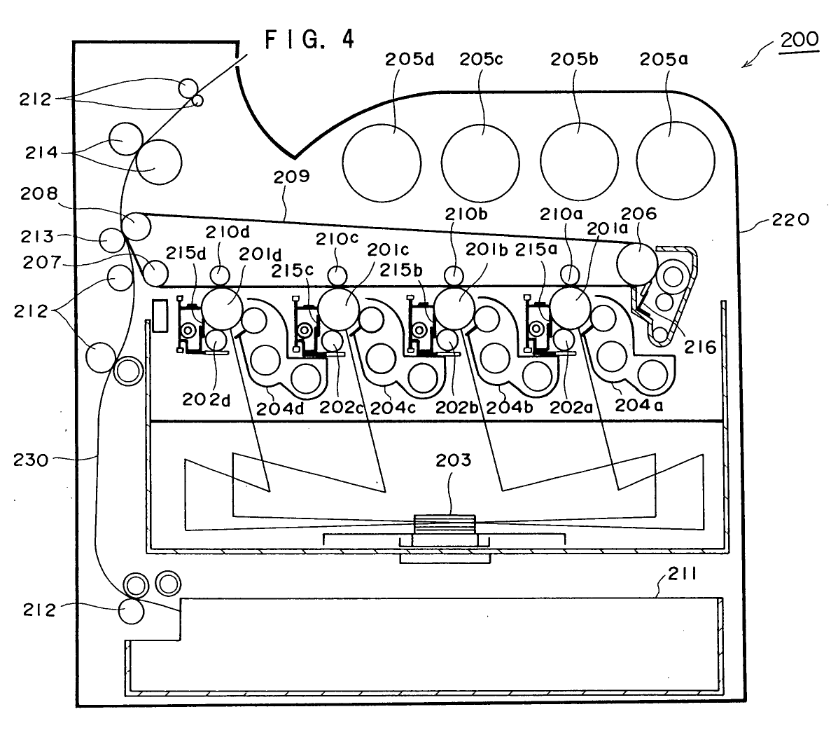

FIG. 4 is a schematic view showing another preferred embodiment of the electrophotographic apparatus of the invention. An electrophotographic apparatus 200 is of a tandem type with intermediate transfer method. In an housing 220, four electrophotographic photoreceptors 201a-201d (for example 201a for yellow color, 201b for magenta color, 201c for cyan color and 201d for black color image formation) are arranged mutually parallel and along an intermediate transfer belt 209.

For transferring a visible image onto a transfer sheet such as paper, a transfer drum method is already known in which the transfer sheet such as paper is wound on a transfer drum and visible images of respective colors on the photoreceptor are transferred onto such transfer sheet. In this case, an transfer drum has to be rotated plural turns for transferring the visible images from the photoreceptors to the transfer sheet, but, in the tandem intermediate transfer method, the transfer from plural photoreceptors 201a-201d can be achieved in a single turn of the intermediate transfer member 209. This transfer method is promising hereafter because of a higher transfer speed thus achieved and an advantage that the transfer medium need not be selective as in the case of the transfer drum method.

The electrophotographic photoreceptors 201a-201d mounted in the electrophotographic apparatus 200 are respectively similar to the electrophotographic photoreceptor 7.

The electrophotographic photoreceptors 201a-201d are respectively rotated in a predetermined direction (counterclockwise in the illustration), and, charging rollers 202a-202d, developing apparatuses 204a-204d, primary transfer rollers 210a-210d, and cleaning apparatuses 215a-215d are arranged along the direction of rotation. Toners of four colors of yellow, magenta, cyan and black, respectively contained in toner cartridges 205a-205d, can be respectively supplied to the developing apparatuses 204a-204d. Also the primary transfer rollers 210a-210d are respectively in contact with the electrophotographic photoreceptors 201a-201d across the intermediate transfer belt 209.

In a predetermined position of the housing 220, a laser light source (exposure apparatus) 203 is positioned. A laser light emitted from the laser light source 203 is so guided to irradiate the surfaces of the electrophotographic photoreceptors 201a-201d after the charging, whereby steps of charging, exposure, development, primary transfer and cleaning are executed in succession in the course of rotation of the electrophotographic photoreceptors 201a-201d, and toner images of the respective colors are transferred in superposition onto the intermediate transfer belt 209.

The intermediate transfer belt 209 is supported under a predetermined tension by a driving roller 206, a backup roller 208 and a tension roller 207, and is rendered rotatable without slack by the rotation of these rollers. A secondary transfer roller 213 is so positioned as to contact the backup roller 208 across the intermediate transfer belt 209.

The intermediate transfer belt 209, after passing between the backup roller 208 and the secondary transfer roller 213, is subjected to a surface cleaning by a cleaning blade 216 positioned for example in the vicinity of the driving roller 206 and is then used again for a next image formation process.

A tray (transfer medium tray) 211 is provided in a predetermined position within the housing 220, and a transfer medium 230 such as paper contained in the tray 211 is transferred, by a transfer roller 212, in a path between the intermediate transfer belt 209 and the secondary transfer roller 213 and also between mutually contacting two fixing rollers 214, and is then discharged to the exterior of the housing 220.

In the foregoing, there has been explained a case in which the intermediate transfer belt 209 is employed as an intermediate transfer member, but the intermediate transfer member may be constructed as a belt shape (for example as an endless belt) as in the case of the intermediate transfer belt 209 or as a drum shape. In case of employing a belt-shaped structure such as the intermediate transfer belt 209 as the intermediate transfer member, such belt preferably has a thickness of 50 to 500 μm, more preferably 60 to 150 μm. The thickness of the belt can be suitably selected according the hardness of the material. Also in case of employing a drum-shaped structure as the intermediate transfer member, a substrate is preferably constituted of a cylindrical substrate formed for example of aluminum, stainless steel (SUS) or copper. On such cylindrical substrate, an elastic layer may be provided if necessary, and a surface layer can be formed on such elastic layer.

The transfer medium mentioned in the invention may be any medium to which a toner image formed on the electrophotographic photoreceptor is transferred. For example, in case of direct transfer from the electrophotographic photoreceptor to a paper or the like, such paper or the like constitutes the transfer medium, and, in case of employing an intermediate transfer member, such intermediate transfer member constitutes the transfer medium.

As the material constituting the aforementioned endless belt, there is proposed a semiconductive endless belt of a thermoplastic material such as a polycarbonate resin (PC), a polyvinylidene fluoride (PVDF), polyalkylene phthalate, a PC/polyalkylene phthalate (PAT) blend, or an ethylene-tetrafluoroethylene copolymer (ETFE).

Also Japanese Patent No. 2560727 and JP-A No. 5-77252 propose an intermediate transfer member in which ordinary carbon black is dispersed as conductive powder in a polyimide resin.

There can be obtained an intermediate transfer member not easily causing an image defect such as a color aberration, since the polyimide resin, having a high Young's modulus, shows little deformation at the driving (under stresses from the supporting roller, cleaning blade and the like). The polyimide resin is usually obtained as a polyamidic acid solution by a polymerization reaction of a tetracarboxylic acid dianhydride or a derivative thereof and a diamine in approximately equimolar amounts in solvent. The tetracarboxylic acid dianhydride is, for example, represented by a following formula (IV): 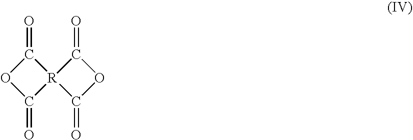
In the formula (IV), R represents a tetravalent organic group selected from a group of an aliphatic linear hydrocarbon group, an alicyclic hydrocarbon group, an aromatic hydrocarbon group, and such hydrocarbon group to which a substituent is bonded.

Specific examples of tetracarboxylic acid dianhydride include pyromellitic acid dianhydride, 3,3′,4,4′-benzophenonetetracarboxylic acid dianhydride, 3,3′,4,4′-biphenyltetracarboxylic acid dianhydride, 2,3,3′,4-biphenyltetracarboxylic acid dianhydride, 2,3,6,7-naphthalenetetracarboxylic acid dianhydride, 1,2,5,6-naphthalenetetracarboxylic acid dianhydride, 1,4,5,8-naphthalenetetracarboxylic acid dianhydride, 2,2′-bis(3,4-dicarboxyphenyl)sulfonic acid dianhydride, perylene-3,4,9,10-tetracarboxylic acid dianhydride, bis(3,4-dicarboxyphenyl) ether dianhydride, and ethylenetetracarboxylic acid dianhydride.

On the other hand, specific examples of diamine include 4,4′-diaminodiphenyl ether, 4,4′-diaminodiphenylmethane, 3,3′-diaminodiphenylmethane, 3,3′-dichlorobenzidine, 4,4′-diaminodiphenylsulfide, 3,3′-diaminodiphenylsulfon, 1,5-diaminonaphthalene, m-phenylenediamine, p-phenylenediamine, 3,3′-dimethyl-4,4′-biphenyldiamine, benzidine, 3,3′-dimethylbenzidine, 3,3′-dimethoxybenzidine, 4,4′-diaminodiphenylsulfon, 4,4′-diaminodiphenylpropane, 2,4-bis(β-amino-tert-butyl)toluene, bis(p-β-amino-tert-butylphenyl)ether, bis(p-β-methyl-δ-aminophenyl)benzene, bis-p-(1,1-dimethyl-5-aminopentyl)benzene, 1-isopropyl-2,4-m-phenylenediamine, m-xylilenediamine, p-xylilenediamine, di(p-aminocyclohexyl)methane, hexamethylenediamine, heptamethylenediamine, octamethylenediamine, nonamethylenediamine, decamethylenediamine, diaminopropyltetramethylene, 3-methylheptamethylenediamine, 4,4-dimethylheptamethylenediamine, 2,11-diaminododecane, 1,2-bis-3-aminopropoxyethane, 2,2-dimethylpropylenediamine, 3-methoxyhexamethylenediamine, 2,5-dimethylheptamethylenediamine, 3-methylheptamethylenediamine, 5-methylnonamethylenediamine, 2,17-diaminoeicosadecane, 1,4-diaminocyclohexane, 1,10-diamino-1,10-dimethyldecane, 12-diaminooctadecane, 2,2-bis[4-4-aminophenoxy)phenyl]propane, piperadine, H₂N(CH₂)₃₀(CH₂)₂₀(CH₂)NH₂, H₂N(CH₂)₃S(CH₂)₃NH₂, and H₂N(CH₂)₃N(CH₃)₂(CH₂)₃NH₂.

A solvent to be used in the polymerization reaction of the tetracarboxylic acid dianhydride and the diamine is advantageously a polar solvent in consideration of solubility and the like. The polar solvent is preferably an N,N-dialkylamide, and more specifically of a lower molecular weight, such as N,N-dimethylformamide, N,N-dimethylacetamide, N,N-diethylformamide, N,N-diethylacetamide, N,N-dimethylmethoxyacetamide, dimethylsulfoxide, hexamethylphosphonyltriamide, N-methyl-2-pyrrolidone, pyridine, tetramethylenesulfone and dimethyltetramethylenesulfone. Such solvent may be employed singly or in a combination of two or more kinds.

The intermediate transfer member contains oxidation-processed carbon black in a polyimide resin. The oxidation-processed carbon black can be obtained by an oxidation process of carbon black thereby providing the surface thereof with an oxygen-containing functional group (such as a carboxyl group, a quinone group, a lactone group or a hydroxyl group).

Such oxidation process can be achieved for example by an air oxidation method of contacting and reacting with the air in a high-temperature environment, a method of contacting with a nitrogen oxide or ozone at the normal temperature, or a method of ozone oxidation at a low temperature after an air oxidation at a high temperature.

Examples of oxidized carbon include products of Mitsubishi Chemical Corp. such as MA100 (pH 3.5, volatiles 1.5%), MA100R (pH 3.5, volatiles 1.5%), MA100S (pH 3.5, volatiles 1.5%), #970 (pH 3.5, volatiles 3.0%), MA11 (pH 3.5, volatiles 2.0%), #1000 (pH 3.5, volatiles 3.0%), #2200 (pH 3.5, volatiles 3.5%), MA230 (pH 3.0, volatiles 1.5%), MA220 (pH 3.0, volatiles 1.0%), #2650 (pH 3.0, volatiles 8.0%), MA7 (pH 3.0, volatiles 3.0%), MA8 (pH 3.0, volatiles 3.0%), OIL7B (pH 3.0, volatiles 6.0%), MA77 (pH 2.5, volatiles 3.0%), #2350 (pH 2.5, volatiles 7.5%), #2700 (pH 2.5, volatiles 10.0%), and #2400 (pH 2.5, volatiles 9.0%); those of Degussa AG such as Printex 150T (pH 4.5, volatiles 10.0%), Special Black 350 (pH 3.5, volatiles 2.2%), Special Black 100 (pH 3.3, volatiles 2.2%), Special Black 250 (pH 3.1, volatiles 2.0%), Special Black 5 (pH 3.0, volatiles 15.0%), Special Black 4 (pH 3.0, volatiles 14.0%), Special Black 4A (pH 3.0, volatiles 14.0%), Special Black 550 (pH 2.8, volatiles 2.5%), Special Black 6 (pH 2.5, volatiles 18.0%), Color Black FW200 (pH 2.5, volatiles 20.0%), Color Black FW2 (pH 2.5, volatiles 16.5%), Color Black FW2V (pH 2.5, volatiles 16.5%); and products of Cabot Corp. such as Monarch 1000 (pH 2.5, volatiles 9.5%), Monarch 1300 (pH 2.5, volatiles 9.5%), Monarch 1400 (pH 2.5, volatiles 9.0%), Mogul-L (pH 2.5, volatiles 5.0%), and Regal 400R (pH 4.0, volatiles 3.5%).

Such oxidation processed carbon black thus obtained is less susceptible to an influence of oxidation which is caused by a locally excessive current under repeated voltage applications. Also the oxygen-containing functional group present on the surface increases the dispersibility into the polyimide resin to reduce a fluctuation in resistance and a dependence on the electric field, thereby decreasing an electric field concentration by the transfer voltage.

As a result, there can be obtained an intermediate transfer member capable of preventing a resistance decrease caused by the transfer voltage, improving the uniformity of electrical resistance, showing a reduced dependence on the electric field, also showing a reduced environmental change in the resistance, and providing a high image quality with reduced image defects such as a white streak on image in a sheet running portion. In case at least two kinds of the oxidation-processed carbon black are included, such oxidation-processed carbon blacks are preferably different substantially in the electroconductivity, and those different in physical properties such as a level of oxidation process, a DBP oil absorption or a BET specific surface area based on nitrogen adsorption.

In case of adding two or more carbon blacks different in the physical properties, it is possible, for example, to. at first add a carbon black providing a high conductivity and then to add a carbon black providing a low conductivity, thereby regulating the surface resistivity or the like.

Specific examples of the oxidation-processed carbon black include Special Black 4 (manufactured by Degussa AG, pH 3.0, volatiles 14.0%) and Special Black 250 (manufactured by Degussa AG, pH 3.1, volatiles 2.0%). A content of such oxidation-processed carbon black is preferably 10 to 50 weight %, more preferably 12 to 30 weight % with respect to the polyimide resin. A content less than 10 weight % may deteriorate the uniformity of the electrical resistance, thereby resulting in a large loss in the surface resistivity in a long-term use, while, at a content exceeding 50 weight %, a desired resistance may be difficult to obtain and a molded product may become undesirably brittle.

An intermediate transfer member of a polyimide resin in which an oxidation-processed carbon black is dispersed can be obtained by a step of preparing a polyamidic acid solution in which an oxidation-processed carbon black is dispersed, a step of forming a film (layer) on an internal peripheryl of a cylindrical mold, and a step of imidation.

For producing a polyamidic acid solution in which two or more types of the oxidation-processed carbon black are dispersed, there are conceived a method of dissolving and polymerizing the acid dianhydride component and the diamine component, in a dispersion liquid in which two or more types of the oxidation-processed carbon black are dispersed in advance in a solvent, and a method of dispersing two or more types of the oxidation-processed carbon black respectively in solvents thereby preparing two or more carbon black dispersion liquids, then dissolving and polymerizing the acid dianhydride component and the diamine component in each dispersion liquid, and mixing the polyamidic acid solutions, and such methods are suitably selected to obtain a polyamidic acid solution in which carbon black is dispersed.

The polyamidic acid solution thus obtained is supplied and developed on an internal periphery of a cylindrical mold to form a film, which is then heated to execute an imidation of the polyamidic acid. In such imidation heating step, an intermediate transfer member with satisfactory surface flatness can be obtained by executing an imidation under a heating condition of maintaining a constant temperature for 0.5 hours or longer. In the following, this process will be explained in detail.

At first a polyamidic acid solution is supplied onto an internal periphery of a cylindrical mold. Such supplying method can be suitable selected such as a supply by a dispenser or by a die. The surface of the internal periphery of the cylindrical mold employed in this step is preferably mirror-finished.

Then thus supplied polyamidic acid solution is formed into a film of a uniform thickness, for example by a centrifugal molding method under heating, a molding method with a bullet-like runner, or a rotation molding method. Subsequently there can be executed a process of heating the mold bearing the film on the internal periphery thereof in a dryer to a temperature causing imidation, or a process of eliminating the solvent until the film can sustain a belt shape, then peeling the film from the internal periphery of the mold and placing the film on an external periphery of a metal cylinder, and heating the film together with the metal cylinder thereby achieving imidation. In order to obtain an intermediate transfer member satisfactory in the flatness and the precision of the external surface, a method of eliminating the solvent until the film can sustain a belt shape, then re-placing the film on an external periphery of the metal cylinder, and executing imidation, is preferable.

A heating condition in the solvent eliminating step is not particularly restricted as long as the solvent can be eliminated, but is preferably 0.5 to 5 hours at 80 to 200° C. Then a molded substance, which can now sustain the form as a belt, is peeled off from the internal periphery of the mold. In this operation, a releasing treatment may be applied to the internal periphery of the mold.

Then the molded substance, which is heated and cured until it can sustain the form of a belt, is re-fitted on an external periphery of a metal cylinder and is heated together with such metal cylinder, thereby causing an imidation reaction of the polyamidic acid.

The metal cylinder to be employed in this step preferably has a linear expansion coefficient larger than that of polyimide resin and is given an external diameter somewhat smaller than the internal diameter of the polyimide molded substance, thereby achieving a thermal setting and obtaining a uniform endless belt of a uniform thickness. The metal cylinder to be employed in this step preferably has a surface roughness (Ra) on the external surface of 1.2 to 2.0 μm. In case the metal cylinder has a surface roughness (Ra) less than 1.2 μm on the external surface, the obtained belt-shaped intermediate transfer member may not cause a slippage by a shrinkage in the axial direction of the metal cylinder because the metal cylinder itself is excessively flat, whereby an extension may be generated in this step to result in a fluctuation in the film thickness and a deteriorated precision of the flatness.

On the other hand, in case the metal cylinder has a surface roughness (Ra) exceeding 2.0 μm on the external surface, the external surface pattern of the metal cylinder may be transferred onto the internal surface of the belt-shaped intermediate transfer member and may generate irregularities on the external surface thereof, thus inducing an image defect. A belt-shaped intermediate transfer member thus prepared of polyimide resin in which carbon black is dispersed has a surface roughness (Ra) of 1.5 μm or less on the external surface.

The surface roughness is measured according to JIS B601. A surface roughness (Ra) of the intermediate transfer member exceeding 1.5 μm may induce an image defect such as a noisy image. This is presumably because an electric field, caused by the voltage applied at the transfer step or by a peeling charging, is locally concentrated on a protruding portion of the belt to modify a surface of such portion, thereby generating a new conductive path with a lower resistance and inducing a lower image density, thus giving a noisy impression on the entire image.

The heating step for imidation is conducted preferably with a heating temperature of 220 to 280° C. and a heating time of 0.5 to 2 hours. The shrinkage at imidation becomes largest in the heating conditions of such range, though it is dependent also on the composition of the polyimide resin, thereby achieving a gradual shrinkage of the belt in the axial direction thereof, thus avoiding deteriorations in the fluctuation of the film thickness and the precision of flatness.

The intermediate transfer member after such heating step has a flatness of 5 mm or less, preferably 3 mm or less. A flatness of 5 mm or less causes no noises and little aberration among the colors. However, in case an edge portion of the belt is curled upward or downward, the belt with a flatness of 5 mm or less may occasionally leave a trace of contact with components in the vicinity, through such belt does not show breakage in the course of use. An intermediate transfer member with a flatness of 3 mm or less does not cause a contact with the components in the vicinity and scarcely shows aberration in the colors.

(Process cartridge)

In the following there will be explained a process cartridge incorporating an electrophotographic photoreceptor of the invention.

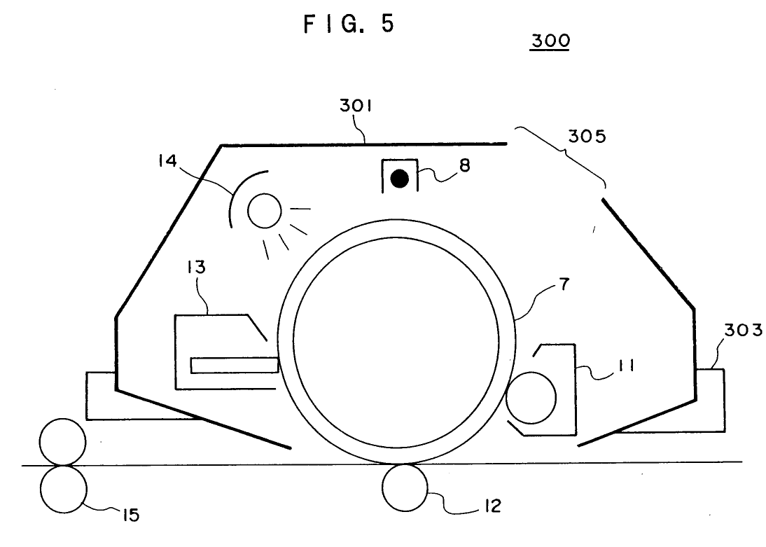

FIG. 5 is a schematic view showing a preferred embodiment of the process cartridge of the invention.

A process cartridge 300 incorporates, within a case 301, an electrophotographic photoreceptor 7, a charging apparatus 8, a developing apparatus 11, a cleaning apparatus 13 and a charge eliminator 14 which are combined and integrated with a rail 303. The process cartridge 300 is not equipped with an exposure apparatus, but has an aperture 305 for exposure in the case 301. The electrophotographic photoreceptor 7 is an aforementioned electrophotographic photoreceptor of the invention, having at least an undercoat layer and a photosensitive layer on a conductive substrate in which the undercoat layer contains metal oxide particles to which an electron acceptor compound is attached.

Such process cartridge 300 is detachably mounted on a main body of an electrophotographic apparatus including a transfer apparatus 12, a fixing apparatus 15 and unillustrated other components, and constitutes an electrophotographic apparatus in cooperation with such main body.

### EXAMPLE

In the following, the present invention will be clarified further by examples, but the present invention is not limited to such examples.

### Example 1

100 parts by weight of zinc oxide (average particle size: 70 nm, manufactured by Teika Co., specific surface area: 15 m²/g) are mixed with 500 parts by weight of tetrahydrofuran under agitation, and agitation is carried out for 2 hours after an addition of 1.25 parts by weight of a silane coupling agent (KBM603, manufactured by Shin-etsu Chemical Co.). Then tetrahydrofuran is distilled off under a reduced pressure, and the obtained mixture is calcined for 3 hours at 120° C. to obtain a zinc oxide pigment surface treated with silane coupling agent.

100 parts by weight of the surface-treated zinc oxide are mixed with 500 parts by weight of tetrahydrofuran under agitation, then a solution formed by dissolving 1 part by weight of alizarin in 50 parts by weight of tetrahydrofuran is added and the mixture is agitated for 5 hours at 50° C. Thereafter, zinc oxide to which alizarin is attached is separated by filtration under a reduced pressure and is dried at 60° C. under a reduced pressure to obtain an alizarin-attached zinc oxide pigment.

60 parts by weight of the alizarin-attached zinc oxide pigment, 38 parts by weight of a solution formed by dissolving 13.5 parts by weight of a curing agent (block isocyanate, Sumidure 3175, manufactured by Sumitomo-Bayer Urethane Co.) and 15 parts by weight of a butyral resin (BM-1, manufactured by Sekisui Chemical Co.) in 85 parts by weight of methyl ethyl ketone, and 25 parts by weight of methyl ethyl ketone, are mixed and dispersed for 2 hours in a sand mill with glass beads of 1 mmφ, to obtain a dispersion liquid.

To the obtained dispersion liquid, 0.005 parts by weight of dioctyl tin dilaurate as a catalyst and 40 parts by weight of silicone resin particles Tospearl 145 (manufactured by GE-Toshiba Silicone Co.) are added to obtain a coating liquid for the undercoat layer. This coating liquid is dip coated on an aluminum substrate of a diameter of 30 mm, a length of 340 mm and a thickness of 1 mm and cured by drying at 170° C. for 40 minutes to obtain an undercoat layer of a thickness of 25 μm.

Then a photosensitive layer is formed on the undercoat layer. At first a mixture of 15 parts by weight of hydroxygallium phthalocyanine having diffraction peaks at Bragg's angle (2θ±0.2°) of 7.3°, 16.0°, 24.9° and 28.0° in a Cukα X-ray diffraction spectrum as a charge generation material, 10 parts by weight of a vinyl chloride-vinyl acetate copolymer resin (VMCH, manufactured by Nippon Unicar Co.) as a binder resin, and 200 parts by weight of n-butyl acetate is subjected to a dispersion for 4 hours in a sand mill with glass beads of 1 mmφ. The obtained dispersion is added with 175 parts by weight of n-butyl acetate and 180 parts by weight of methyl ethyl ketone and agitated to obtain a coating liquid for a charge generation layer. This coating liquid for the charge generation layer is dip coated on the undercoat layer and dried at the normal temperature to obtain a charge generation layer of a thickness of 0.2 μm.

Then a coating liquid, formed by dissolving 4 parts by weight of N,N′-diphenyl-N,N′-bis(3-methylphenyl)-[1,1′]biphenyl-4,4′-diamine and 6 parts by weight of a bisphenol-Z-polycarbonate resin (molecular weight: 40,000) in 80 parts by weight of chlorobenzene, is coated on the charge generation layer and dried for 40 minutes at 135° C. to obtain a charge transport layer of a thickness of 32 μm, thereby completing an electrophotographic photoreceptor.

The electrophotographic photoreceptor thus obtained, in a test for a print quality by mounting on a full-color printer Docu Centre Color C400, manufactured by Fuji Xerox Co. and equipped with a contact charging apparatus and an intermediate transfer apparatus, provides a satisfactory image quality.

The electrophotographic photoreceptor is subjected to a continuous print test of 10,000 prints in a high-temperature high-humidity condition (28° C., 40%RH) and a low-temperature low-humidity condition (15° C., 10% RH), and shows an excellent constancy without an abnormality in image density or an image defect such as a fog or a black spot, and without a black spot by a leak defect. Results are shown in Table 11.

### Examples 2-4

Electrophotographic photoreceptors are prepared in the same manner as in Example 1 except that the acceptor compound attached in Example 1 to the zinc oxide surface treated with the silane coupling agent is changed to substances shown in Table 1, and are subjected to an evaluation of characteristics. Results are shown in Table 11.

### Comparative Example 1

An electrophotographic photoreceptor is prepared in the same manner as in Example 1 except that zinc oxide that is surface treated with the silane coupling agent but without the attachment of alizarin is employed, and is subjected to an evaluation of characteristics. Results are shown in Table 11.

TABLE 11

| | | Print test under high | | Print test under low | |
|---|---|---|---|---|---|
| | Electron acceptor | temperature and high humidity | | temperature and low humidity | |
| | compound | initial print test | 10,000th print test | initial print test | 10,000th print test |
| Example 1 | alizarin | abnormal image- | abnormal image- | abnormal image- | abnormal image- |
| | | density: absent | density: absent | density: absent | density: absent |
| | | fog, black spot: absent | fog, black spot: absent | fog, black spot: absent | fog, black spot: absent |
| Example 2 | 1-hydroxy | abnormal image- | abnormal image- | abnormal image- | abnormal image- |
| | anthraquinone | density: absent | density: absent | density: absent | density: absent |
| | | fog, black spot: absent | fog, black spot: absent | fog, black spot: absent | fog, black spot: absent |
| Example 3 | purpurin | abnormal image- | abnormal image- | abnormal image- | abnormal image- |
| | | density: absent | density: absent | density: absent | density: absent |
| | | fog, black spot: absent | fog, black spot: absent | fog, black spot: absent | fog, black spot: absent |
| Example 4 | 2-amino-3-hydroxy- | abnormal image- | abnormal image- | abnormal image- | abnormal image- |
| | anthraquinone | density: absent | density: absent | density: absent | density: absent |
| | | fog, black spot: absent | fog, black spot: absent | fog, black spot: absent | fog, black spot: absent |
| Comp. Ex. 1 | — | abnormal image- | abnormal image- | abnormal image- | abnormal image- |
| | | density: absent | density: found | density: absent | density: found |
| | | fog, black spot: absent | fog: found | fog, black spot: absent | fog: found |
| | | | black spot: found | | black spot: found |

What is claimed is:

1. An electrophotographic photoreceptor comprising a conductive substrate, and at least an undercoat layer and a photosensitive layer on the conductive substrate, wherein the undercoat layer includes metal oxide fine particles to which an electron acceptor compound is attached.

2. The electrophotographic photoreceptor according to claim 1, wherein the electron acceptor compound is a compound having a quinone group.

3. The electrophotographic photoreceptor according to claim 1, wherein the compound having a quinone group is a compound having an anthraquinone structure.

4. The electrophotographic photoreceptor according to claim 1, wherein the compound having an anthraquinone structure is at least one selected from a group consisting of a hydroxyanthraquinone compound, an aminoanthraquinone compound and an aminohydroxyanthraquinone compound.

5. The electrophotographic photoreceptor according to claim 1, wherein the compound having an anthraquinone structure is at least one selected from group consisting of anthraquinone, alizarin, quinizarin, anthrarufin and purpurin.

6. The electrophotographic photoreceptor according to claim 1, wherein the metal oxide fine particles are surface treated with a coupling agent prior to the attaching of the acceptor compound.

7. The electrophotographic photoreceptor according to claim 6, wherein the coupling agent is a silane coupling agent.

8. The electrophotographic photoreceptor according to claim 7, wherein the silane coupling agent is a silane coupling agent having an amino group.

9. The electrophotographic photoreceptor according to claim 1, wherein the metal oxide fine particles contain at least one selected from group consisting of titanium oxide, zinc oxide, tin oxide and zirconium oxide.

10. The electrophotographic photoreceptor according to claim 1, wherein the undercoat layer has a thickness of 15 μm or larger.

11. The electrophotographic photoreceptor according to claim 1, wherein the electron acceptor compound is attached by 0.01 to 20 weight % with respect to the metal oxide fine particles.

12. An electrophotographic cartridge comprising:
an electrophotographic photoreceptor including at least a conductive substrate, and at least an undercoat layer and a photosensitive layer on the conductive substrate, in which the undercoat layer includes metal oxide fine particles to which an electron acceptor compound is attached; and
a contact charging apparatus maintained in contact with and serving for charging the electrophotographic photoreceptor.

13. The electrophotographic cartridge according to claim 12, wherein the electron acceptor compound is a compound having a quinone group.

14. The electrophotographic cartridge according to claim 12, wherein the electron acceptor compound having a quinone group is a compound having an anthraquinone structure.

15. An electrophotographic apparatus comprising:
an electrophotographic photoreceptor including a conductive substrate and at least an undercoat layer and a photosensitive layer on the conductive substrate, in which the undercoat layer includes metal oxide fine particles to which an electron acceptor compound is attached; and
a contact charging apparatus maintained in contact with and serving for charging the electrophotographic photoreceptor.

16. The electrophotographic apparatus according to claim 15, wherein the electron acceptor compound is a compound having a quinone group.

17. The electrophotographic apparatus according to claim 15, wherein the electron acceptor compound having a quinone group is a compound having an anthraquinone structure.

18. An electrophotographic apparatus comprising:
an electrophotographic photoreceptor including a conductive substrate and at least an undercoat layer and a photosensitive layer on the conductive substrate, in which the undercoat layer includes metal oxide fine particles to which an electron acceptor compound is attached; and
an intermediate transfer apparatus for transferring an image formed on the electrophotographic photoreceptor.

19. The electrophotographic apparatus according to claim 18, wherein the electron acceptor compound is a compound having a quinone group.

20. The electrophotographic apparatus according to claim 18, wherein the electron acceptor compound having a quinone group is a compound having an anthraquinone structure.
